(19) United States
(12) Patent Application Publication
(10) Pub. No.: US 2009/0033589 A1
(43) Pub. Date: Feb. 5, 2009

(54) Image Display Device

(76) Inventor: Toshifumi Ozaki, Koganei (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/127,851

(22) Filed: May 28, 2008

(30) Foreign Application Priority Data
Aug. 1, 2007 (JP) 2007-200340
Aug. 1, 2007 (JP) 2007-200358

(51) Int. Cl. G09G 3/20

(52) U.S. Cl. 345/55

(57) ABSTRACT

An increase in the circuit size of a drive circuit that accompanies multi-gradation is reduced. Herein, VI0 to VIM are modulation circuit reference voltages in which a prescribed range, i.e., from a non-emission voltage VEOFF to a maximum emission voltage VEON, is divided in M equal parts. Higher-order dividing resistor (40) equally divides the parts of the modulation circuit reference voltages VI0 to VIM (where VI0>VI1 . . . >VIM−1>VIM) and generates 2^{J}+1 higher-order gradation voltages v0 to v8M (where 8M is equal to 2^{J}) A higher-order decoder unit (41) selects two adjacent voltages from the higher-order gradation voltages in accordance with the data of the higher-order J bits held in the data latch. Complimentary MOSFET selection switches (47-1) and (47-2) open and close in accordance with the lowest-order bit data inputted to the higher-order decoder unit (41). A lower-order dividing resistor (43) equally divides the voltage between the selected high-voltage higher-order gradation voltage vl and the low-voltage higher-order gradation voltage v1+1, and generates 2^{K} gradation voltages vl0 to vln−1 (where n is equal to 2^{K}). A lower-order decoder unit (44) selectively outputs an output voltage from the gradation voltages generated by the dividing resistors in accordance with the data of the lower-order K bits held in the data latch.

### CROSS-REFERENCE TO RELATED APPLICATIONS

The present application claims priority from Japanese applications JP 2007-200358 and JP2007-200340 filed on Aug. 1, 2007, the content of which is hereby incorporated by reference into this application.

### BACKGROUND OF THE INVENTION

1. Field of the Invention

The present invention relates to an image display device, and more particularly relates to an image display device in which the increase in a circuit size of a drive circuit that accompanies multi-gradation can be reduced.

2. Description of the Related Art

In an image display device referred to as a flat panel display (FPD), a resistance-dividing scheme is known as one type of amplitude modulation drive circuit for modulating a voltage amplitude signal to display gradations. In this scheme, a reference voltage inputted from the exterior is divided by a resistor, a gradation voltage thus generated is selected by a selection circuit and outputted to a display panel, and an image is displayed.

This resistance-dividing scheme is widely used in drive circuits of thin film transistor-type (TFT) liquid crystal displays (i.e., active matrix displays). Application of the resistance-dividing scheme is also being considered for the drive circuits of image display devices that use MIM (Metal-Insulator-Metal) or other electron emission elements. In recent years, multi-gradation that exceeds 10 bits has come to be needed in this type of drive circuit to increase color reproducibility, improve contrast ratio, and enhance other areas of panel performance. With the resistance-dividing scheme, however, there is a problem in that the chip size of a semiconductor integrated circuit composed of a drive circuit is increased and the cost of the drive circuit is also increased because the number of switches constituting a gradation voltage selection circuit, and the lines that transmit voltage from a resistor to a selection circuit, are increased by two-bit multiples in accompaniment with multi-gradation.

Japanese Laid-open Patent Publication No. 2-130586 and U.S. Pat. No. 6,246,351 B1 have been disclosed as prior arts in this field. In Japanese Laid-open Patent Publication No. 2-130586, image information is divided into higher-order image information and lower-order image information, two adjacent higher-order gradation voltages that correspond to the higher-order image information are selected from a plurality of higher-order gradation voltages that correspond to the number of bits of higher-order image information, and division is carried out between the two selected higher-order gradation voltages by using resistance in accordance with the number of bits of lower-order image information to generate and output an image signal, making it possible to prevent an increase in the chip size of a semiconductor integrated circuit as a drive circuit, as well as an increase in the higher-cost drive circuit, that accompany multi-gradation.

In U.S. Pat. No. 6,246,351 B1, division is carried out between two selected voltages in accordance with the number of bits of lower-order image information with the aid of an output circuit that has a lower-order decoder unit, a switch, and a multi-input differential pair, and an image signal is generated and outputted, making it possible to prevent an increase in the chip size of a semiconductor integrated circuit as a drive circuit, as well as an increase in the higher-cost drive circuit, that accompany multi-gradation.

In Japanese Patent No. 3433337, common fixed driving is carried out in which a common voltage is set to be constant in an image display device, voltages that have positive polarity and negative polarity in relation to the common voltage are applied in alternating fashion to pixel electrodes, and voltage applied to the liquid crystal is converted to AC. When this type of driving is performed, adjacent digital analog converting means for generating a positive polarity voltage and a negative polarity voltage are provided, and the positive voltage and negative voltage outputted from these conversion means are alternately applied to a signal line at a prescribed cycle to reduce the circuit scale and chip size.

### SUMMARY OF THE INVENTION

However, two sets of selection switches are used in Japanese Laid-open Patent Publication No. 2-130586 and U.S. Pat. No. 6,246,351 B1 in the higher-order decoder unit in order to select two adjacent higher-order tones. Therefore, the surface area occupied by the higher-order decoder unit is widened, the circuit scale of the drive circuit that accompanies multi-gradation is increased, and the chip size of a semiconductor integrated circuit and the cost of the drive circuit are increased as well as a result when the configuration is implemented using the semiconductor integrated circuit.

In the method of Japanese Laid-open Patent Publication No. 2-130586, there is a problem in that when a reference voltage inputted from the exterior is divided by resistors to generate higher-order gradation voltages, the higher-order gradation voltages vary and the gradation characteristics cannot be correctly reproduced because the resistors that divide the voltage between the higher-order gradation voltages are connected in parallel between two selected adjacent higher-order gradation voltages. Also, in Japanese Patent No. 3433337, no consideration is given to implementing the method of Japanese Laid-open Patent Publication No. 2-130586.

An object of the present invention is to provide an image display device in which an increase in the circuit size of the drive circuit that accompanies multi-gradation is reduced.

The image display device according to a first aspect of the present invention comprises: a display panel having a plurality of mutually parallel row lines, a plurality of column lines that intersect with the row lines, a back surface plate in which display elements are disposed in a vicinity of the intersections of the row lines and the column lines to form a display area, and a front surface plate superposed so as to cover at least the display area of the back surface plate.

The back surface plate has a scanning circuit which is connected to the row lines and which performs row selection, and a modulation circuit which is connected to the column lines and which outputs amplitude modulation voltage. The modulation circuit has a higher-order gradation voltage generator that has a higher-order dividing resistor for dividing an externally inputted modulation circuit reference voltage and generating higher-order gradation voltages, a data latch for holding display data, and a decoder composed of a higher-order decoder unit for selecting two adjacent voltages from the higher-order gradation voltages in accordance with the data of the higher-order bits held in the data latch, and a lower-order decoder unit for dividing the voltage between two selected higher-order gradation voltages and generating a gradation voltage to selectively output an output voltage of voltage dividing means for outputting the gradation voltage generated in accordance with the data of the lower-order bits held in the data latch.

The higher-order decoder unit has a switch for selecting an adjacent even-numbered or odd-numbered higher-order gradation voltage that is higher or lower than an odd-numbered or an even-numbered higher-order gradation voltage of the higher-order decoder unit, and the decoder further has a selection switch for selecting the output voltage of the voltage dividing means between the higher-order decoder unit and the voltage dividing means.

In another aspect of the present invention, the higher-order decoder unit is composed of a p-channel MOSFET for selecting a high-voltage higher-order gradation voltage, and an n-channel MOSFET for selecting a low-voltage higher-order gradation voltage; and the lower-order decoder unit is composed of a complimentary MOSFET in which a p-channel MOSFET and an n-channel MOSFET are connected in parallel.

The image display device according to yet another aspect of the present invention comprises: a display panel having a plurality of mutually parallel row lines, a plurality of column lines that intersect with the row lines, a back surface plate in which display elements are disposed in a vicinity of the intersections of the row lines and the column lines to form a display area, and a front surface plate superposed so as to cover at least the display area of the back surface plate. The back surface plate has a scanning circuit which is connected to the row lines and which performs row selection, and a modulation circuit which is connected to the column lines and which outputs amplitude modulation voltage.

The modulation circuit has a decoder having a higher-order gradation voltage generator that has a higher-order dividing resistor for dividing an externally inputted modulation circuit reference voltage and generating higher-order gradation voltages, a data latch for holding display data, a higher-order decoder unit for selecting two adjacent voltages from the higher-order gradation voltages in accordance with the data of the higher-order bits held in the data latch, a lower-order dividing resistor for dividing the voltage between the two selected higher-order gradation voltages and generating a gradation voltage, and a lower-order decoder unit for selectively outputting an output voltage from a gradation voltage generated in accordance with the data of the lower-order bits held in the data latch. Also, a buffer amplifier is provided between the higher-order dividing resistor and the lower-order dividing resistor.

In still another aspect of the present invention, the buffer amplifier is disposed between an output of the higher-order decoder unit and an input terminal of the lower-order dividing resistor.

In yet another aspect of the present invention, the decoder has signal pathway switching means for providing input via the same buffer amplifier in a case in which the higher-order gradation voltages are inputted to a high-voltage terminal of the lower-order dividing resistor or in a case in which the input is made to the low-voltage terminal.

In still another aspect of the present invention, the signal pathway switching means is composed of a switch which is provided to the higher-order decoder unit and which is used for selecting an adjacent even-numbered or odd-numbered higher-order gradation voltage that is higher or lower than an odd-numbered or even-numbered higher-order gradation voltage of the higher-order decoder unit, and a selection switch provided to the buffer amplifier.

In yet another aspect of the present invention, the higher-order decoder unit is composed of a p-channel MOSFET for selecting a high-voltage higher-order gradation voltage, and an n-channel MOSFET for selecting a low-voltage higher-order gradation voltage; and the lower-order decoder unit is composed of a complimentary MOSFET in which a p-channel MOSFET and an n-channel MOSFET are connected in parallel.

The selection switches in the higher-order decoder unit can be configured as a single set, and the number of switches constituting the decoder can be reduced by half. In contrast, two sets of such switches are required in conventional practice. Also, a selection switch on the input side of the buffer amplifier is no longer required. As a result, an increase in the circuit scale of the drive circuit can be made smaller, and the chip size of a semiconductor integrated circuit can be reduced when the circuits are implemented using a semiconductor integrated circuit. The configuration of the MOSFET of the higher-order decoder unit in which the inputted voltage is fixed can be simplified, and an increase in the on-resistance during selection can be prevented even if there are variations in the higher-order gradation voltage inputted to the lower-order decoder unit.

A buffer amplifier is disposed between the output of the higher-order decoder unit and the input terminal of the lower-order dividing resistor, and signal pathway switching means is provided for inputting via the same buffer amplifier, whereby the lower-order dividing resistor is connected in parallel between two adjacent higher-order gradation voltages and there are no variations in the higher-order gradation voltages.

The signal pathway switching means is composed of a switch which is provided to the higher-order decoder unit and which is used for selecting an adjacent even-numbered or odd-numbered higher-order gradation voltage that is higher or lower than an odd-numbered or even-numbered higher-order gradation voltage of the higher-order decoder unit, and is further composed of a selection switch provided to the buffer amplifier. Accordingly, variability between the two voltages does not become larger than that between other gradations, and image quality does not degrade even if the buffer amplifier output voltage deviation is considerable.

The higher-order decoder unit is composed of a p-channel MOSFET for selecting a high-voltage higher-order gradation voltage, and an n-channel MOSFET for selecting a low-voltage higher-order gradation voltage; and the lower-order decoder unit is composed of a complimentary MOSFET in which a p-channel MOSFET and an n-channel MOSFET are connected in parallel. Accordingly, the chip size of the data driver is reduced. Also, the configuration of the MOSFET of the higher-order decoder unit in which the inputted voltage is fixed can be simplified, and the on-resistance during selection does not increase even if there are variations in the higher-order gradation voltage inputted to the lower-order decoder unit.

### BRIEF DESCRIPTION OF THE DRAWINGS

FIG. 1 is a block diagram showing the overall circuit configuration of the image display device described in example 1 of the image display device according to the present invention;

FIG. 2 is a block diagram showing the configuration of the modulation circuit shown in FIG. 1;

FIG. 3 is a block diagram showing the configuration of the scanning circuit shown in FIG. 1;

FIG. 4 is a detailed schematic view of the unit of each column of a decoder and a higher-order gradation voltage generator in the data driver shown in FIG. 2;

FIG. 5 is a circuit diagram showing the details of the higher-order decoder unit in FIG. 4;

FIG. 6 is a circuit diagram showing the details of the lower-order decoder unit in FIG. 4;

FIG. 7 is a schematic circuit diagram showing the higher-order decoder unit of the image display device and describing example 2 of the image display device according to the present invention;

FIG. 8 is a block diagram showing the overall circuit configuration of the image display device and describing example 3 of the image display device according to the present invention;

FIG. 9 is a block diagram of the data driver that constitutes the modulation circuit of FIG. 8;

FIG. 10 is a block diagram of the higher-order decoder unit of example 3 of the image display device according to the present invention;

FIG. 11 is a circuit diagram showing the details of the lower-order decoder unit of FIG. 4 in the positive-pole decoder of example 3 of the image display device according to the present invention;

FIG. 12 is a block diagram showing the details of the unit of each column of a decoder and a higher-order gradation voltage generator in the data driver of FIG. 2 in example 4 of the image display device according to the present invention;

FIG. 13 is a circuit diagram showing the details of the lower-order decoder unit of FIG. 12;

FIG. 14 is a circuit diagram showing the details of the unit of each column of the output circuit in the data driver of FIG. 2 in example 4 of the image display device according to the present invention;

FIG. 15 is a block diagram showing the details of the unit of each column of the decoder and the higher-order gradation voltage generator in the data driver shown in FIG. 2;

FIG. 16 is a circuit diagram showing the details of the higher-order decoder unit in FIG. 15;

FIG. 17 is a block diagram showing the overall circuit configuration of example 6 of the image display device according to the present invention;

FIG. 18 is a block diagram showing the details of the unit of each column of the decoder shown in FIG. 15 of example 7 of the image display device according to the present invention;

FIG. 19 is a block diagram showing the details of the unit of each column of the decoder shown in FIG. 15 of example 8 of the present invention;

FIG. 20 is circuit diagram showing the details of the higher-order decoder unit 91 in FIG. 19;

FIG. 21 is circuit diagram showing the details of the higher-order decoder unit of example 9 of the image display device according to the present invention;

FIG. 22 is a block diagram showing the overall circuit configuration of example 10 of the image display device according to the present invention;

FIG. 23 is a block diagram of the data driver constituting the modulation circuit in FIG. 22;

FIG. 24 is a circuit diagram showing the configuration of the positive-pole higher-order decoder unit in example 10 of the present invention; and

FIG. 25 is a circuit diagram showing the details of the lower-order decoder unit shown in FIG. 19 of the positive-pole decoder unit in example 10 of the present invention.

### DETAILED DESCRIPTION OF THE INVENTION

Preferred embodiments of the present invention are described in detail below using examples.

### EXAMPLE 1

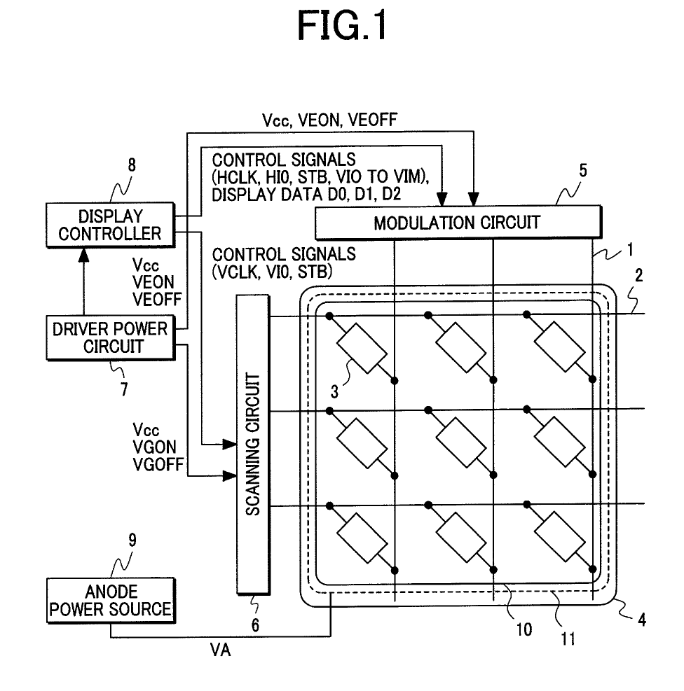

FIG. 1 is a block diagram showing the overall circuit configuration of the image display device described in example 1 of the image display device according to the present invention. In the present example, the present invention has been applied to an image display device that uses MIM electron emission elements. The inner surface has a display panel 4 in which a back surface plate and a front surface plate (not shown) are laminated to each other. Glass is preferably used as the back surface plate on which are formed column lines 1, row lines 2, and MIM electron emission elements 3 disposed in the vicinity of the intersections of the column lines 1 and row lines 2. A fluorescent film 10 and a metal back (anode) 11 formed over the fluorescent film 10 are formed on the inner surface of the front surface plate facing the display area in which the MIM electron emission elements 3 of the back surface plate are disposed.

In the case of a full-color display, the fluorescent film 10, which is excited by electrons emitted from the MIM electron emission elements 3 and emits light, has a plurality of fluorescent films for emitting red, green, blue, and other primary colors disposed in a prescribed pattern. The front surface plate is superposed on the back surface plate so as to cover the display area on which at least the fluorescent film 10 and the metal back (anode) 11 are formed.

A modulation voltage is applied to each of the MIM electron emission elements 3, in which emission intensity is modulated by the modulation voltage, via the column line 1 connected to a lower-order electrode. A frame-shaped side wall (not shown) is formed on the periphery of the panel in order to form a vacuum inside the panel. The element also has the back surface plate provided with row lines 2 connected to the higher-order electrodes of the MIM electron emission elements 3, and further has the front surface plate provided with the fluorescent film 10 on the surface facing the back surface plate and with the metal back 11 formed so as to cover the fluorescent film 10. The fluorescent film 10 is coated with three primary colors, i.e., red, green, and blue, for each column of the MIM electron emission elements 3.

Reference numeral 5 is a modulation circuit for outputting an amplitude modulation voltage to the row lines, and reference numeral 6 is a scanning circuit for selecting rows. A driver power source 7 supplies a selection voltage VGON, a non-selection voltage VGOFF, and a logic circuit voltage Vcc to the scanning circuit 6, and supplies an emission voltage VEON, a non-emission voltage VEOFF, and a logic circuit voltage Vcc to the modulation circuit 5 and a display controller 8. The display controller 8 presents the scanning circuit 6 with a vertical clock VCLK, a start pulse VIO, and an output switching signal STB, and presents the modulation circuit 5 with a horizontal clock HCLK, a start pulse HIO, an output switching signal STB, a modulation circuit reference voltage VI0 to VIM, and display data D0, D1, D2 of three output I bits that correspond to red, green, and blue. These control signals, as well as signals other than the reference voltages VI0 to VIM for the modulation circuit in the data, all have the amplitude of the logic circuit voltage Vcc. An anode power source 9 presents the metal back (anode) 11 with an anode voltage VA for causing the fluorescent body to emit light.

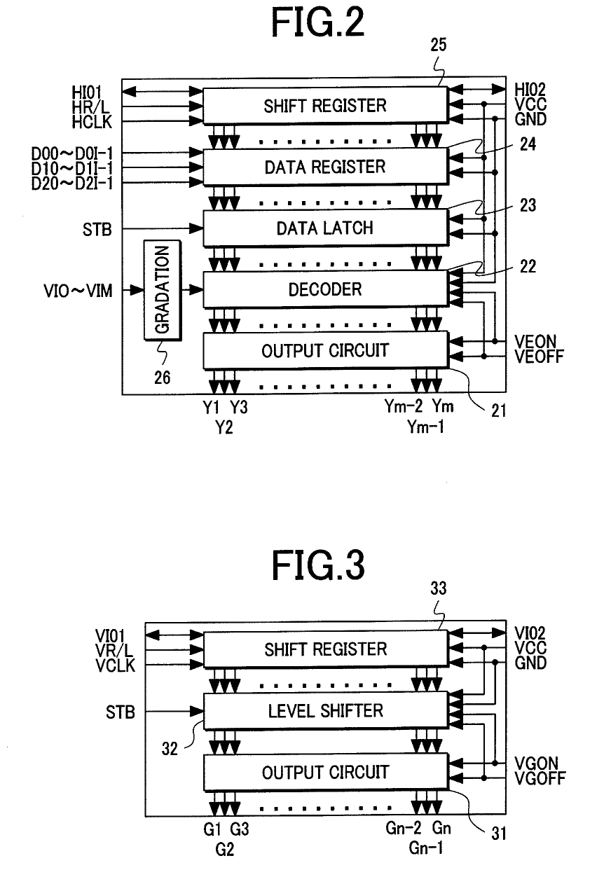

FIG. 2 is a block diagram showing the configuration of the modulation circuit shown in FIG. 1. The modulation circuit 5 has a data driver composed of semiconductor integrated circuits in a series connection. Reference numeral 25 is a shift register for generating a latch signal for receiving display data. Reference numeral 24 is a data register for sequentially receiving display data composed of three output I bits, i.e., D00 to D0I-1, D10 to D1I-1, D20 to D2I-1, that correspond to red, green, and blue simultaneously inputted from the display controller 8. Reference numeral 23 is a data latch for receiving and holding the display data of the data register in synchronization with the output switching signal STB.

Reference numeral 26 is a higher-order gradation voltage generator for generating 2^{J}+1 higher-order gradation voltages by resistance division from the modulation circuit reference voltages VI0 to VIM that are outputted from the display controller 8. Reference numeral 22 is a decoder for generating and outputting 2^{I} (I>J) voltages by using the 2^{J} (1 higher-order gradation voltages in accordance with the I bits of display data outputted from the data latch. Reference numeral 21 is an output circuit composed of a voltage follower for outputting a decoder output voltage to each of the column lines 1 of the display panel 4 as output voltages Y1 to Ym. HR(L is a signal for determining the shift direction of the shift register, and is fixed to the logic circuit voltage Vcc or the ground voltage GND.

When a single horizontal scanning interval is started, a start pulse HIO is inputted as an HIO1 (or HIO2) signal of a first data driver, and the registers in the shift register 25 perform a shift operation in synchronization with the horizontal clock HCLK. When a latch signal is outputted, the three simultaneously outputted I bits of display data are sequentially received by the data register 24. When the display data has been received by the data register 24 of the first data driver, the voltage of HIO2 (or HIO1) is converted to the logic circuit voltage Vcc and is inputted to HIO1 (or HIO2) of the second data driver, and the receipt of the display data into the second data driver is started. When the receipt of all display data into the data register 24 is completed in this manner, all display data is received from the data register 24 into the data latch 23 in synchronization with the rise of the output switching signal STB immediately prior to the single horizontal scanning interval. The display data thus received is converted to gradation voltages by the decoder 22, and the gradation voltages are outputted to the column lines via the output circuit 21.

FIG. 3 is a block diagram showing the configuration of the scanning circuit shown in FIG. 1. The scanning circuit 6 of FIG. 1 has a scan driver composed of the semiconductor integrated circuits shown in FIG. 3 in a series connection. Reference numeral 33 is a shift register for generating a selection signal that is used to sequentially switch the selected rows for each horizontal scanning interval. Reference numeral 32 is a level shifter for converting the shift register output from the level of the logic circuit voltage Vcc-GND to the level of the selection voltage VGON-non-selection voltage VGOFF. Reference numeral 31 is an output circuit for outputting the selection voltage VGON or the non-selection voltage VGOFF to each of the row lines 2 of the display panel 4 as output voltages G1 to Gn in accordance with the shift register output level thus shifted. The VR/L is a signal for determining the shift direction of the shift register and is fixed to the logic circuit voltage Vcc or the ground voltage GND.

When a single vertical scanning interval is started, a start pulse VIO is inputted as a VIO1 (or VIO2) signal of a first scan driver, and the registers in the shift register 33 perform a shift operation in synchronization with the vertical clock VCLK for each single horizontal scan interval, and the selection signals are outputted in a sequential fashion. The logic product that combines the selection signal thus outputted and the inverted signal of the output switching signal STB is shifted by a level shifter 32 to the level of the selection voltage VGON-non-selection voltage VGOFF, and is outputted as the selection voltage VGON to the selected row lines of the display panel 4. On the other hand, the non-selection voltage VGOFF is outputted to the unselected row lines of the display panel 4. When the shift in the first scan driver has been completed, the voltage of VIO2 (or VIO1) assumes the value of the logic circuit voltage Vcc; VIO1 (or VIO2) of the second scan driver is inputted; and the shift in the second scan driver is started. All rows are sequentially selected in this manner.

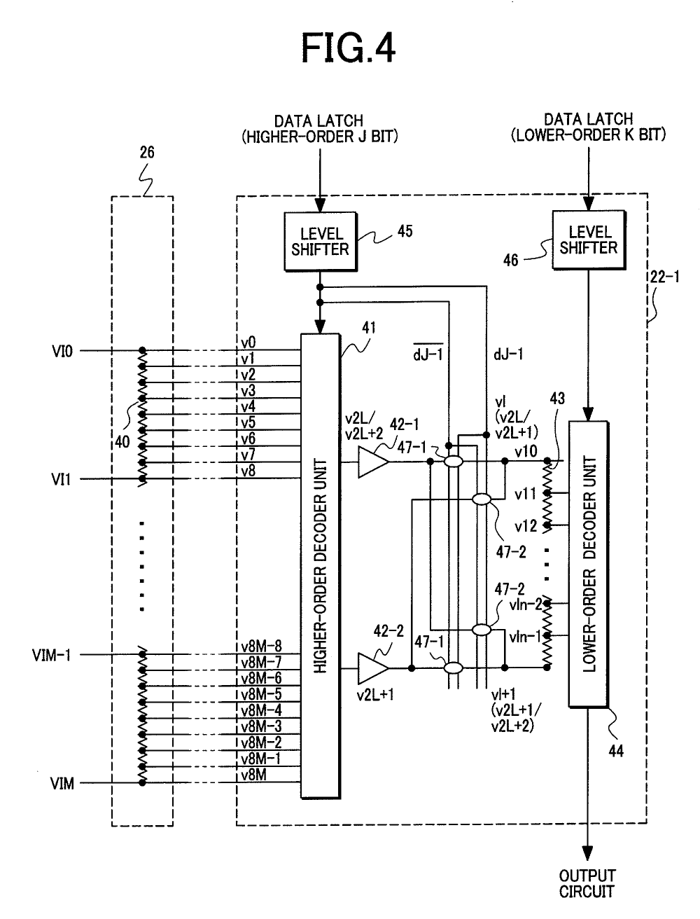

FIG. 4 is a detailed schematic view of the unit of each column of a decoder and a higher-order gradation voltage generator in the data driver shown in FIG. 2. In the diagram, VI0 to VIM are the modulation circuit reference voltages in which a prescribed range, i.e., from the non-emission voltage VEOFF to the maximum emission voltage VEON, is equally divided into M parts. In FIG. 4, reference numeral 40 is a higher-order dividing resistor that equally divides the parts of the modulation circuit reference voltages VI0 to VIM (where VI0>VI1 . . . >VIM−1>VIM) and generates 2^{J}+1 higher-order gradation voltages v0 to v8M (where 8M is equal to 2^{J}). Reference numerals 45 and 46 are level shifters for converting data latch output from the level of the logic circuit voltage Vcc-GND to a level between the non-emission voltage VEOFF and the maximum emission voltage VEON.

Reference numeral 41 is a higher-order decoder unit for selecting two adjacent voltages from the higher-order gradation voltages in accordance with the data of the higher-order J bits held in the data latch. Reference numerals 42-1 and 42-2 are buffer amplifiers composed of voltage followers. Reference numerals 47-1 and 47-2 are complimentary MOSFET selection switches that are opened and closed by the lowest-order bit data inputted to the higher-order decoder unit 41. Reference numeral 43 is a lower-order dividing resistor for equally dividing the voltage between the selected high-voltage higher-order gradation voltage vl and the low-voltage higher-order gradation voltage vl+1, and generating 2^{K} gradation voltages vl0 to vln−1 (where n is equal to 2^{K}). Reference numeral 44 is a lower-order decoder unit for selectively outputting an output voltage from the gradation voltages generated by the dividing resistors in accordance with the data of the lower-order K bits held in the data latch.

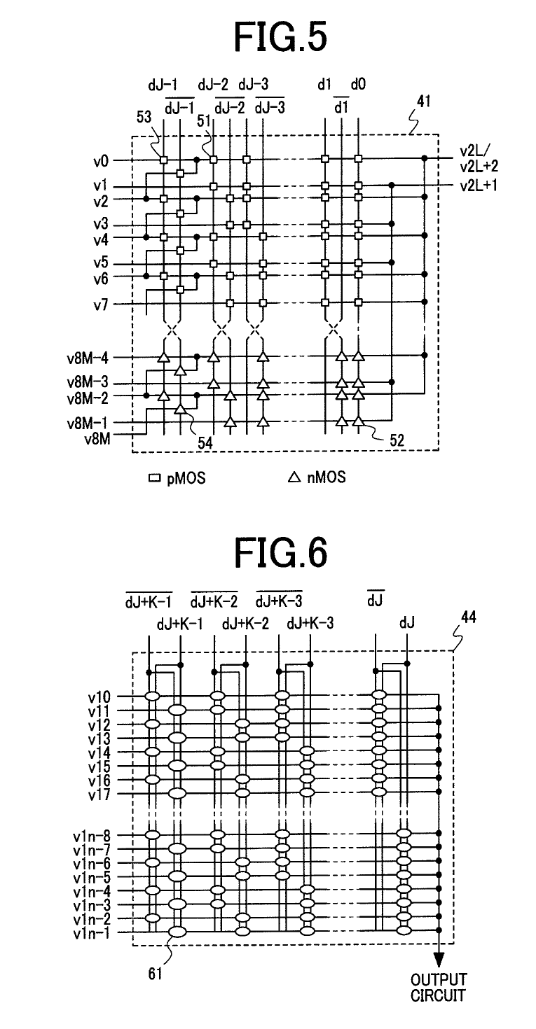

FIG. 5 is a circuit diagram showing the details of the higher-order decoder unit in FIG. 4. In FIG. 5, the reference numerals with horizontal lines drawn thereabove are inverted signals of the signal indicated by the reference numeral. However, in the specification below, inverted signals appear in parentheses, such as). In other words, d0, d1, . . . , dJ-3, dJ-2, dJ-1 and (d0), (d1), . . . , (dJ-3), (dJ-2), (dJ-1) indicate, respectively, signals in which the data latch output of the higher-order J bits has been shifted in level, and the inverted signals thereof.

The symbol “□” (white square) at the intersections of the lines in FIG. 5 refers to a pMOSFET, and the symbol “Δ” (white triangle) refers to an nMOSFET (simply notated as pMOS and nMOS in FIG. 5). In the diagram, d0 corresponds to the highest-order bit and dJ-1 corresponds to the lowest-order bit. The reference numerals V0 to v8M are higher-order gradation voltages. Reference numerals 51, 52 are p-channel MOSFET selection switches and n-channel MOSFET selection switches, and reference numerals 53, 54 are p-channel MOSFET selection switches and n-channel MOSFET selection switches for selecting an adjacent even-numbered higher-order gradation voltage of either a higher or lower odd-numbered higher-order gradation voltage in accordance with the lowest-order bit data inputted to the higher-order decoder unit 41.

In this case, 8M/2 voltages of the high-voltage higher-order gradation voltage v0 to v8M/2−1 are selected by the p-channel MOSFETs 51 and 53, and 8M/2+1 voltages of the low-voltage higher-order gradation voltage v8M/2 to v8M are selected by the n-channel MOSFETs 52 and 54. The level-shifted signals or the inverted signals thereof are inputted to the gates of the MOSFETS, and two adjacent voltages are selected from among the higher-order gradation voltages v0 to v8M.

FIG. 6 is a circuit diagram showing the details of the lower-order decoder unit 44 in FIG. 4. In FIG. 6, dJ, dJ+1, . . . , dJ+K−3, dJ+K−2, dJ+K−1, and (dJ), (dJ+1), . . . , (dJ+K−3), (dJ+K−2), (dJ+K−1) indicate, respectively, signals in which the data latch output of the lower-order K bits has been shifted in level, and the inverted signals thereof. The signal dJ corresponds to the highest-order bit and dJ+K−1 corresponds to the lowest-order bit. The reference numeral 61 is a complimentary MOSFET selection switch in which a p-channel MOSFET and an n-channel MOSFET are connected in parallel. The level-shifted signals or the inverted signals thereof are inputted to the gates of the MOSFETS, and output voltages are selectively outputted from among the gradation voltages vl0 to vln−1.

The modulation circuit reference voltages VI0 to VIM are equally divided by the higher-order dividing resistor 40, and higher-order gradation voltages v0 to v8M are generated. Two adjacent higher-order gradation voltages vl and vl+1 are selected from the generated higher-order gradation voltages by the higher-order decoder unit 41 in accordance with the higher-order J bit data held in the data latch. When the lowest-order bit is 0 (1 is an even number 2L), the level-shifted signal dJ−1 is brought to a low level, and the high-voltage higher-order gradation voltage v2L is inputted to the buffer amplifier 42-1 and is applied to the higher-voltage side of the lower-order dividing resistor 43 via the selection switch 47-1. The low-voltage higher-order gradation voltage v2L+1 is inputted to the buffer amplifier 42-2 and is applied to the low-voltage side of the lower-order dividing resistor 43 via the selection switch 47-1.

On the other hand, when the lowest-order bit is 1 (1 is an odd number 2L+1), the inverted signal dJ−1 is brought to a low level, and the high-voltage higher-order gradation voltage v2L+L is inputted to the buffer amplifier 42-2 in a similar manner as when the lowest-order bit is 0, and is then applied to the high-voltage input terminal of the lower-order dividing resistor 43 via the selection switch 47-2. The low-voltage higher-order gradation voltage v2L+2 is inputted to the buffer amplifier 42-1 and is applied to the lower-voltage input terminal of the lower-order dividing resistor 43 via the selection switch 47-2.

In the present embodiment, the higher-order decoder unit 41 has switches 52, 54 for selecting an adjacent even-numbered higher-order gradation voltage that is higher or lower than an odd-numbered higher-order gradation voltage of the higher-order decoder unit. The decoder has selection switches between the higher-order decoder unit and the lower-order dividing resistor 43 for dividing the voltage between the selected adjacent higher-order gradation voltages and outputting the result, as well as between the lower-order decoder unit 44 and the output circuit. The two switches perform switching in accordance with the lowest-order bit data inputted to the higher-order decoder unit, and select two adjacent higher-order gradations. As a result, the selection switches in the higher-order decoder unit can be configured in as a single set, the number of switches constituting the decoder can be reduced by half, and the chip size of the data driver can be reduced. In contrast, two sets of such switches are required in conventional practice.

The even-numbered higher-order gradation voltage is inputted to the lower-order dividing resistor 43 via the buffer amplifier 42-1, and the odd-numbered higher-order gradation voltage is inputted to the lower-order dividing resistor 43 via the buffer amplifier 42-2 both in cases in which input is made to the high-voltage terminal and in cases in which input is made to the low-voltage terminal of the lower-order dividing resistor 43. As a result, both the maximum voltage vl0 outputted by the lower-order decoder unit when a particular higher-order gradation voltage is selected as the high-voltage higher-order gradation voltage, and the lowest voltage vl−1n−1 outputted by the lower-order decoder unit when a particular gradation voltage of a single prior gradation is selected as the low-voltage higher-order gradation voltage, are affected by the output voltage deviation of the same buffer amplifier 42-1 or 42-2. Accordingly, variability between the two voltages does not become larger than that between other gradations, and image quality does not degrade even if the buffer amplifier output voltage deviation is considerable.

The higher-order decoder unit is composed of a p-channel MOSFET for selecting a high-voltage higher-order gradation voltage, and an n-channel MOSFET for selecting a low-voltage higher-order gradation voltage. The lower-order decoder unit is composed entirely of complimentary MOSFETS in which a p-channel MOSFET and an n-channel MOSFET are connected in parallel.

In accordance with the configuration of example 1, the configuration of the MOSFETs of the higher-order decoder unit fixed to an inputted voltage can be simplified, an increase in the on-resistance during selection can be prevented even if the higher-order gradation voltage inputted to the lower-order decoder unit varies, and an increase in the circuit size of the drive circuit that accompanies multi-gradation can be reduced.

### EXAMPLE 2

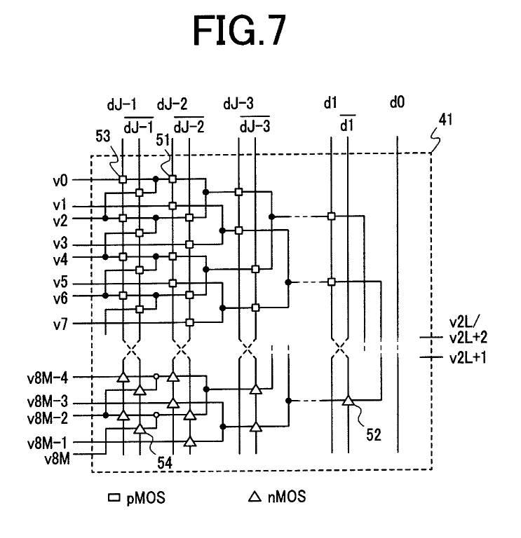

Example 2 is an example of another configuration of the higher-order decoder unit in example 1. FIG. 7 is a schematic circuit diagram of the higher-order decoder unit showing the image display device and describing example 2 of the image display device according to the present invention. The overall configuration of example 2 is the same as that of FIG. 4. In FIG. 7, the symbol “□” (white square) at the intersections of the lines refers to a pMMOSFET, and the symbol “Δ” (white triangle) refers to an nMMOSFET (simply notated as pMOS and nMOS in FIG. 7). In the higher-order decoder unit 41 of FIG. 7, the function of d0, d1, . . . , dJ-3, dJ-2, dJ-1 and (d0), (d1), . . . , (dJ-3), (dJ-2), (dJ-1), v0 to v8M, and the reference numerals 51, 52, 53, 54 are the same as those of FIG. 5.

In example 2 as well, the number of switches constituting the decoder is reduced by half, the chip size of the data driver can be made smaller, and an increase in the circuit size of a drive circuit that accompanies multi-gradation can be reduced as well.

### EXAMPLE 3

The present invention may also be implemented in image display devices that use any type of display panel as long as the panel is driven by amplitude modulation. Example 3 is an example in which the present invention has been applied to a TFT liquid crystal display device driven by dot inversion. Driving by dot inversion is a type of common fixed driving in which the polarity of a voltage applied to pixel electrodes is inverted for each column and each row.

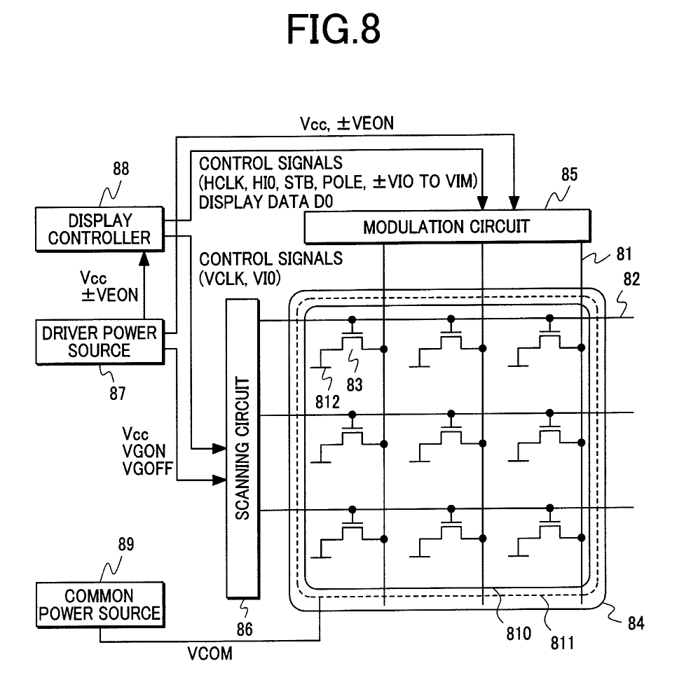

FIG. 8 is a block diagram showing the overall circuit configuration of the image display device and describing example 3 of the image display device according to the present invention. A display panel 84 is composed of a back surface plate that is provided with TFTs 83, column lines 81 connected to the TFTs 83, row lines 82 connected to the gate electrodes of the TFTs 83, and pixel electrodes 812 for holding a modulation voltage applied to the column lines; a front surface plate provided with a common electrode 811 on the surface facing the back surface plate; and a liquid crystal 810 which is sealed between the front and back surface plates and which varies light transmittance by using the modulation voltage held in the pixel electrodes.

Reference numeral 85 is a modulation circuit for outputting an amplitude modulation voltage to the column lines, and reference numeral 86 is a scanning circuit for selecting rows. A driver power source 87 supplies a selection voltage VGON, a non-selection voltage VGOFF, and a logic circuit voltage Vcc to the scanning circuit 86, and supplies a positive or negative emission voltage ±VEON and a logic circuit voltage Vcc to the modulation circuit 85 and a display controller 88. The display controller 88 supplies a vertical clock VCLK and a start pulse VIO to the scanning circuit 86, and presents the modulation circuit 85 with a horizontal clock HCLK, a start pulse HIO, an output switching signal STB, an output positive/negative switching signal POLE, a positive/negative modulation circuit reference voltage ±VI0 to VIM, and display data D0.

Of these control signals and data, signals other than the modulation circuit reference voltages ±VI0 to VIM have the amplitude of the logic circuit voltage Vcc. A common power source 89 presents the common electrode 811 with a common voltage VCOM, which is a reference for the voltage applied to the liquid crystal 810.

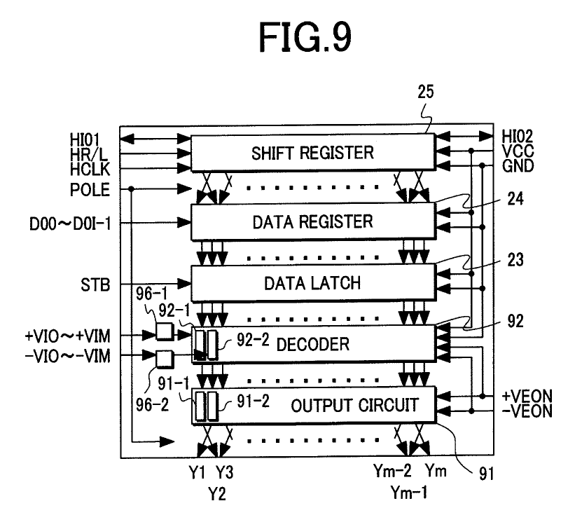

FIG. 9 is a block diagram of the data driver that constitutes the modulation circuit of FIG. 8. The modulation circuit 85 has a data driver composed of semiconductor integrated circuits in a series connection. Reference numerals 25, 24, and 23 are the same as those in FIG. 2. In the diagram, +VI0 to +VIM (+VI0<+VI1, . . . <+VIM−1<+VIM) are positive modulation circuit reference voltages having a divided prescribed range, i.e., from the positive maximum emission voltage VEON to the common voltage. Reference numerals −VI0 to −VIM (−VI0>−VI1, . . . >−VIM−1>−VIM) are negative modulation circuit reference voltages having a divided prescribed range, i.e., from the negative maximum emission voltage −VEON to the common voltage.

Reference numerals 96-1 and 96-2 are positive-pole or negative-pole higher-order gradation voltage generators in which resistance division is used to generate 2^{j}+1 number of positive or negative higher-order gradation voltages from the positive modulation circuit reference voltages +VI0 to VIM or the negative modulation circuit reference voltages −VI0 to VIM, respectively. Reference numerals 92-1 and 92-2 are positive-pole or negative-pole decoder units for generating and outputting 2^{I} (I>J) voltages by using the number 2^{J}+1 of positive or negative higher-order gradation voltages in accordance with I bits of display data outputted by the data latch. Reference numerals 91-1 and 91-2 are positive-pole or negative-pole output circuits composed of voltage followers for outputting the decoder output voltages as the output voltages Y1 to Ym to the column lines 81 of the display panel 84. The positive-pole decoder and output circuit, as well as the negative-pole decoder and output circuit, are alternately disposed for each column. HR/L is a signal for determining the shift direction of the shift register and is fixed to the logic circuit voltage Vcc or the ground voltage GND.

When a single horizontal scanning interval is started, a start pulse HIO is inputted as an HIO1 (or HIO2) signal of a first data driver, and the registers in the shift register 25 perform a shift operation in synchronization with the horizontal clock HCLK. When a latch signal is outputted, I bits of display data are sequentially received by the data register 24. When the display data has been received by the data register 24 of the first data driver, the voltage of the HIO2 (or HIO1) assumes the value of the logic circuit voltage Vcc and is inputted to HIO1 (or HIO2) terminal of the second data driver, and the receipt of the display data into the second data driver is started.

When the receipt of all display data into the data register 24 is completed in this manner, all the display data is received from the data register 24 into the data latch 23 in synchronization with the rise of the output switching signal STB immediately prior to the single horizontal scanning interval. The display data thus received into the data latch 23 is converted to gradation voltages by the positive-pole decoder 92-1 or the negative-pole decoder 92-2, and the gradation voltages thus converted are outputted to the column lines via the positive-pole output circuit 91-1 or the negative-pole output circuit 91-2. As a result of the above, a voltage that is positive or negative in relation to the common voltage VCOM is outputted in alternating fashion to the column lines.

The output positive/negative switching signal POLE assumes the values 0 and 1 in alternating fashion for each horizontal scanning interval, and the voltage output to the column lines is made positive or negative for each horizontal scan line. When the output positive/negative switching signal POLE is 0, the display data corresponding to the output to the odd-numbered column lines is received by the odd-numbered addresses of the data register 24 and is outputted to the odd-numbered column lines Y1, Y3, . . . as positive voltage by the positive-pole decoder unit 92-1 and the positive-pole output circuit 91-1. The display data corresponding to the output to the even-numbered column lines is received by the even-numbered addresses of the data register 24, is converted to negative voltage by the negative-pole decoder unit 92-2 and the negative-pole output circuit 91-2, and is outputted to the even-numbered column lines Y2, . . . as negative voltage.

On the other hand, when the output positive/negative switching signal POLE is 1, the display data corresponding to the output to the odd-numbered column lines is received by the even-numbered addresses of the data register 24, and is outputted to the odd-numbered column lines Y1, Y3, . . . as negative voltage by the negative-pole decoder 92-2 and the negative-pole output circuit 91-2. The display data corresponding to the output to the even-numbered column lines is received by the odd-numbered addresses of the data register 24, is converted to negative voltage by the positive-pole decoder unit 92-1 and the positive-pole output circuit 91-1, and is outputted to the even-numbered column lines Y2, . . . as negative voltage. As a result of the above, the output positive/negative switching signal POLE is switched, whereby the voltage output to the column lines assumes the value of a positive or negative voltage for each of the horizontal scanning lines.

The positive-pole or the negative-pole higher-order gradation voltage generators 96-1 and 96-2 in the data driver shown in FIG. 9 are the same as reference numeral 26 of FIG. 4, and the overall configuration of the units of each column of the positive-pole or the negative-pole decoder units 92-1 and 92-2 is the same as 22-1 of FIG. 4.

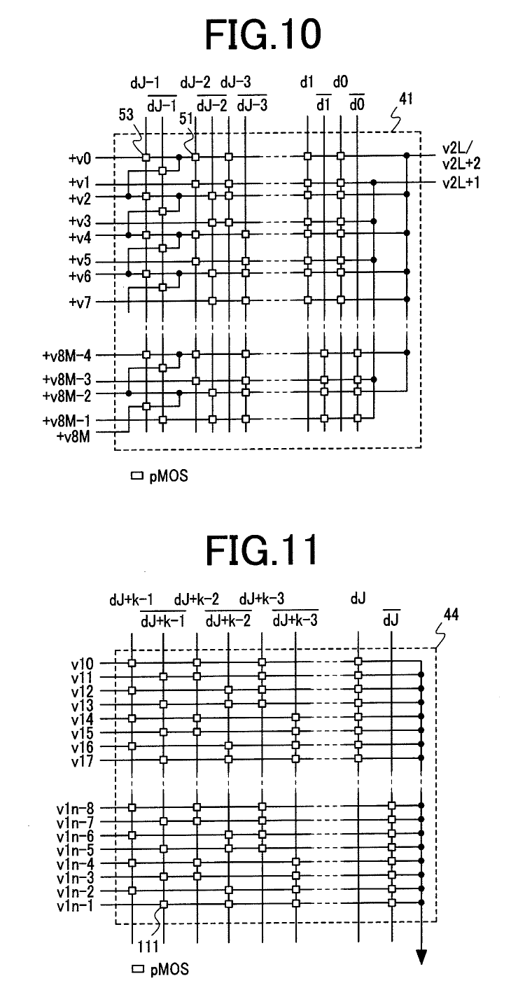

FIG. 10 is a block diagram of the higher-order decoder unit 91 of example 3 of the image display device according to the present invention. In the positive-pole decoder, the selection switches 47-1, 47-2 are composed of p-channel MOSFETS. In the higher-order decoder unit 91, d0, d1, . . . , dJ-3, dJ-2, dJ-1 and (d0), (d1), (dJ-3), (dJ-2), (dJ-1) indicate, respectively, signals in which the data latch output of the higher-order J bits has been converted from the level of the logic circuit voltage Vcc-GND to a positive maximum emission voltage +VEON and a negative maximum emission voltage −VEON, and the inverted signals thereof. In the diagram, d0 corresponds to the highest-order bit, and dJ−1 corresponds to the lowest-order bit. Also, +v0 to +v8M are positive higher-order gradation voltages.

Reference numerals 51, 53 are p-channel MOSFET selection switches in the same manner as FIG. 5. The level-shifted signals or the inverted signals thereof are inputted to the gates of the p-channel MOSFETs, respectively, and two adjacent voltages v2L+1 and v2L or v2L+2 are selected from among the positive higher-order gradation voltages +v0 to +v8M in the same manner as in FIG. 5.

FIG. 11 is a circuit diagram showing the details of the lower-order decoder unit 44 of FIG. 4 in the positive-pole decoder of example 3 of the image display device according to the present invention. In the diagram, dJ, dJ+1, . . . , dJ+K−3, dJ+K−2, dJ+K−1, and (dJ), (dJ+1), . . . , (dJ+K−3), (dJ+K−2), (dJ+K−1) indicate, respectively, signals in which the data latch output of the lower-order K bits has been shifted in level, and the inverted signals thereof. The signal dJ corresponds to the highest-order bit, and dJ+K−1 corresponds to the lowest-order bit.

The reference numeral 111 is a p-channel MOSFET selection switch. The level-shifted signals or the inverted signals thereof are inputted to the gates of the MOSFETS, and output voltages are selectively outputted from among the gradation voltages vl0 to vln−1 that are generated by equally dividing the voltage between the two adjacent higher-order gradation voltages vl and vl+1.

On the other hand, in the negative-pole decoder, the selection switches 47-1, 47-2 of FIG. 4, the selection switches 51, 53 of the higher-order decoder unit shown in FIG. 10, and the selection switch 111 of the lower-order decoder unit shown in FIG. 11 are all composed of an n-channel MOSFET. The higher-order decoder unit and the lower-order decoder unit are presented with a level shift signal obtained by converting the data latch output from the level of the logic circuit voltage Vcc-GND to a positive maximum emission voltage +VEON and a negative maximum emission voltage −VEON, and a polarity-inverted signal thereof.

In the present embodiment, the higher-order decoder unit and the lower-order decoder unit of the positive-pole decoder are composed of p-channel MOSFETs, and the higher-order decoder unit and the lower-order decoder unit of the negative-pole decoder are composed of n-channel MOSFETs, whereby the configuration of the decoder can be simplified and the chip size of the data driver can be reduced.

### EXAMPLE 4

The present invention is not limited to a method in which the voltage is outputted having been divided between two selected adjacent higher-order voltages. Example 4 is one in which the voltage is divided between two selected adjacent higher-order voltages by a lower-order decoder unit and an output circuit having a multi-input differential pair.

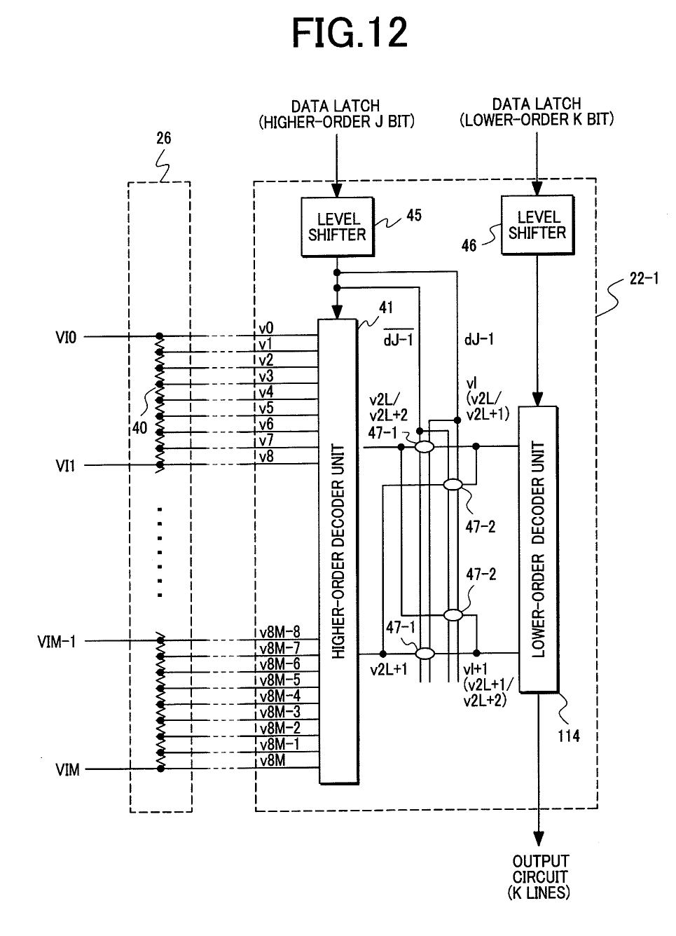

FIG. 12 is a block diagram showing the details of the unit 22-1 of each column of a decoder 22 and a higher-order gradation voltage generator 26 in the data driver of FIG. 2 in example 4 of the image display device according to the present invention. In the diagram VI0 to VIM, v0 to v8M, 40, 41, 45, 46, 47-1, and 47-2 are the same as in FIG. 4. Reference numeral 114 is a lower-order decoder unit for presenting an output circuit either with the high-voltage higher-order gradation voltage vl selected for each bit in accordance with the data of the lower-order K bits held in the data latch, or with the low-voltage higher-order gradation voltage vl+1, as well as with the number K+1 of the high-voltage higher-order gradation voltages vl.

The modulation circuit reference voltages VI0 to VIM are equally divided by the higher-order dividing resistor 40 and higher-order gradation voltages V0 to v8M are generated. The two adjacent higher-order gradation voltages vl and vl+1 are selected from the generated higher-order gradation voltages by the higher-order decoder unit 41 in accordance with the higher-order J bit data held in the data latch. When the lowest-order bit is 0 (1 is an even number 2L), the shifted signal dJ−1 is brought to a low level, and the high-voltage higher-order gradation voltage v2L is applied to the input of the high-voltage side of the lower-order decoder unit 114 via the selection switch 47-1. The low-voltage higher-order gradation voltage v2L+1 is applied to the input of the low-voltage side of the lower-order decoder unit 114 via the selection switch 47-1. On the other hand, when the lowest-order bit is 1 (1 is an odd number 2L+1), the inverted signal dJ−1 is brought to a low level, and the high-voltage higher-order gradation voltage v2L+1 is applied to the high-voltage input terminal of the lower-order decoder unit 114 via the selection switch 47-2. The low-voltage higher-order gradation voltage v2L+2 is applied to the lower-voltage input terminal of the lower-order decoder unit 114 via the selection switch 47-2.

FIG. 13 is a circuit diagram showing the details of the lower-order decoder unit 114 of FIG. 12. In FIG. 13, dJ, dJ+1, dJ+K−3, dJ+K−2, dJ+K−1, the inverted signals thereof, and the reference numeral 61 are the same as in FIG. 6. In the diagram INJ, . . . , INJ+K−3, INJ+K−2, INJ+K−1 are either the high-voltage higher-order gradation voltages vl or the low-voltage higher-order gradation voltages vl+1 selected for each bit in accordance with the data of the lower-order K bits.

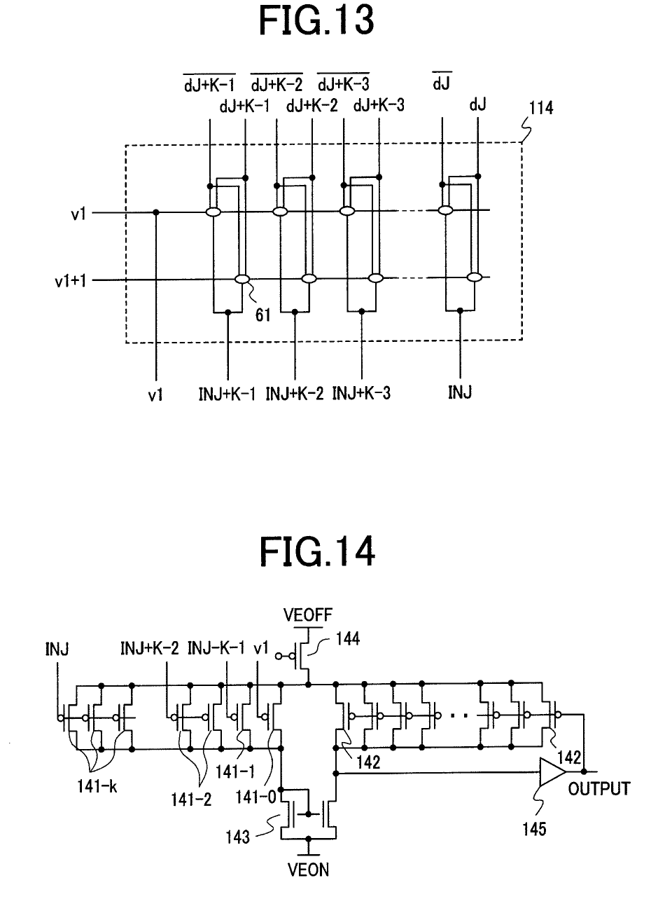

FIG. 14 is a circuit diagram showing the details of the unit of each column of the output circuit 21 in the data driver of FIG. 2 in example 4 of the image display device according to the present invention. VEON, VEOFF are the same as in FIG. 1, vl is the same as in FIG. 4, and INJ, . . . , INJ+K−3, INJ+K−2, INJ+K−1 are the same as in FIG. 13. Reference numeral 141 is a MOSFET on the input side of the differential pair, reference numeral 142 is a MOSFET on the output side of the differential pair, reference numeral 143 is a negative load MOSFET, reference numeral 144 is a constant-current source MOSFET, and reference numeral 145 is an output buffer amplifier.

The size of the MOSFETs constituting the differential pair for improving the uniformity of the output voltage is the same. The high-voltage higher-order gradation voltage vl is inputted to the MOSFET 141-0 on the input side, the input voltage INJ+K−1 that corresponds to the data of the lowest-order bit is inputted to the MOSFET 141-1 on the input side, and the input voltage INJ+K−2 that corresponds to the data of the second bit is inputted to two MOSFETs 141-2 on the input side. In the same manner hereinafter, the input voltage INJ that corresponds to the data of the Kth bit is inputted to 2^{K=1} MOSFETs 141-K on the input side. On the other hand, the output-side MOSFET gates composed of a total of 2^{K} MOSFET gates, which is the same number as on the input side of the differential pair, are connected to the outputs of the output buffer 145.

In the diagram, INJ, . . . , INJ+K−3, INJ+K−2, INJ+K−1, vl, which have either the high-voltage higher-order gradation voltages vl or the low-voltage higher-order gradation voltages vl+1 for each bit in accordance with the data outputted by the lower-order decoder unit, are inputted to the gates of MOSFETs that number 2^{K=1}, . . . , 2², 1, 1 and are disposed on the input side of the differential pair.

As a result, the output voltage of the output circuit is vl+X/2^{K} (where X is a decimal number of the lower-order K bits), which is obtained by dividing the voltage between the high-voltage higher-order gradation voltage vl and the low-voltage higher-order gradation voltage vl+1 in accordance with the data of the lower-order K bits.

In the present embodiment, the higher-order decoder unit 41 has switches 52, 54 for selecting an adjacent even-numbered higher-order gradation voltage that is higher or lower than an odd-numbered higher-order gradation voltage of the higher-order decoder unit. The decoder has selection switches between the higher-order decoder unit, the lower-order decoder unit 114 for dividing the voltage between the selected adjacent higher-order gradation voltages and outputting the result, and the output circuit shown in FIG. 14. The two switches perform switching in accordance with the lowest-order bit data inputted to the higher-order decoder unit, and select two adjacent higher-order gradations. As a result, the selection switches in the higher-order decoder unit can be configured as a single set, the number of switches constituting the decoder can be reduced by half, and the chip size of the data driver can be reduced. In contrast, two sets of such switches are required in conventional practice.

The high-voltage higher-order gradation voltage vl or the low-voltage higher-order gradation voltage vl+1 is outputted from the lower-order decoder unit for each bit in accordance with the data, and the voltages are inputted to the gates of MOSFETs that number 2^{K=1}, . . . , 2², 2, 1, 1 and are disposed on the input side of the differential pair in the output circuit, whereby the voltage is divided between the higher-order gradation voltages, and the output voltage is selected. As a result, the circuit configuration of the lower-order decoder unit can be simplified and the chip size of the data driver can be reduced.

In examples 1, 2, and 4, the modulation circuit reference voltages VI0 to VIM are voltages obtained by equally dividing a prescribed range, i.e., from the non-emission voltage VEOFF to the maximum emission voltage VEON, into M parts. However, an unequal division may also be used in accordance with the required display quality and the relationship between the voltage of the electron emission element and the emission current characteristics toward the front surface plate. The parts of the modulation circuit reference voltages VI0 to VIM are equally divided by the higher-order dividing resistor 40 to generate higher-order gradation voltages v0 to v8M. In a similar manner, an unequal division may also be used in accordance with the required display quality and the relationship between the voltage of the electron emission element and the emission current characteristics toward the front surface plate.

In example 3, a case was described in which a display controller 8 outputs display data DO for a monochrome display, but the present invention can also be implemented in the same manner in a case in which three outputs, i.e., display data D0, D1, D2, for a color display are outputted.

In example 3, a common electrode 1211 is provided to the front surface plate, but the present invention can also be implemented in the same manner for a case in which a common electrode is located on the front surface plate in the same manner as in an in-plane switching liquid crystal.

In examples 1 to 4, a switch for selecting an adjacent even-numbered higher-order gradation voltage that is higher or lower than an odd-numbered higher-order gradation voltage of the higher-order decoder unit is provided as signal pathway switching means to the higher-order decoder unit, but it is apparent that a switch for selecting an adjacent odd-numbered higher-order gradation voltage that is higher or lower than an even-numbered higher-order gradation voltage of the higher-order decoder unit may be provided.

Next, examples 5 to 10 of the present invention will be described in detail with reference to the drawings. In examples 5 to 10 described below, a buffer amplifier is disposed between a higher-order dividing resistor and a lower-order dividing resistor.

### EXAMPLE 5

Example 5 is one in which the present invention is applied to an image display device that uses MIM (Metal Insulator Metal) electron emission elements. The block diagrams of the overall circuit, the modulation circuit 5, the scanning circuit 6, and the lower-order decoder unit 44 of the image display device according to example 5 are the same as those shown in FIGS. 1, 2, 3, and 6, and a detailed description is therefore omitted.

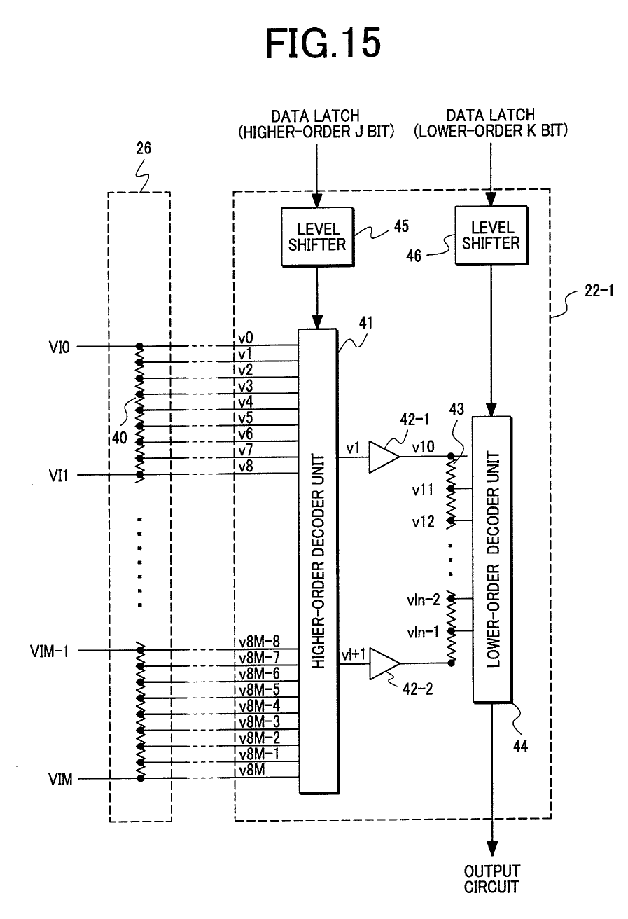

FIG. 15 is a block diagram showing the details of the unit 22-1 of each column of the decoder 22 and the higher-order gradation voltage generator 26 in the data driver of FIG. 2 according to example 5. In FIG. 15, VI0 to VIM are the modulation circuit reference voltages in which a prescribed range, i.e., from the non-emission voltage VEOFF to the maximum emission voltage VEON, is equally divided into M parts. Reference numeral 40 is a higher-order dividing resistor that equally divides the parts of the modulation circuit reference voltages VI0 to VIM (where VI0>VI1 . . . >VIM−1>VIM) and generates 2^{J}+1 higher-order gradation voltages v0 to v8M (where 8M is equal to 2^{J}). Reference numerals 45 and 46 are level shifters for converting data latch output from the level of the logic circuit voltage Vcc-GND to a level between the non-emission voltage VEOFF and the maximum emission voltage VEON. Reference numeral 41 is a higher-order decoder unit for selecting two adjacent voltages vl and vl+1 from the higher-order gradation voltages in accordance with the data of the higher-order J bits held in the data latch.

In the diagram, vl and vl+1 are the selected high-voltage higher-order gradation voltage and low-voltage higher-order gradation voltage, respectively, and 42-1 and 42-2 are buffer amplifiers composed of voltage followers. Reference numeral 43 is a lower-order dividing resistor for equally dividing the voltage between the selected high-voltage higher-order gradation voltage vl and the low-voltage higher-order gradation voltage vl+1 and generating 2^{K} gradation voltages vl0 to vln−1 (where n is equal to 2^{K}). Reference numeral 44 is a lower-order decoder unit for selectively outputting an output voltage from the gradation voltages generated by the dividing resistors in accordance with the data of the lower-order K bits held in the data latch.

The modulation circuit reference voltages VI0 to VIM are equally divided by the higher-order dividing resistor 40, and higher-order gradation voltages V0 to v8M are generated. Two adjacent higher-order gradation voltages vl and vl+1 are selected from the generated higher-order gradation voltages by the higher-order decoder unit 41 in accordance with the higher-order J bit data held in the data latch. The high-voltage higher-order gradation voltage vl is inputted to the terminal on the high-voltage side of the lower-order dividing resistor 43 via the buffer amplifier 42-1. The low-voltage higher-order gradation voltage vl+1 is applied to the input terminal on the low-voltage side of the lower-order dividing resistor 43 via the buffer amplifier 42-2. The lower-order dividing resistor 43 equally divides the voltage between the two voltages thus inputted, and gradation voltages vl0 to vln−1 are generated. An output voltage is selectively outputted by the lower-order decoder unit 44 from the generated gradation voltages in accordance with the data of the lower-order K bits.

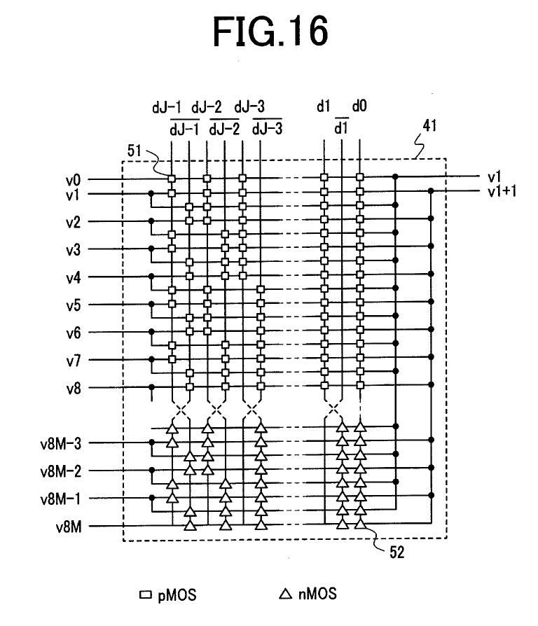

FIG. 16 is a circuit diagram showing the details of the higher-order decoder unit 41 in FIG. 15. In FIG. 16, the reference numerals with horizontal lines drawn thereabove are inverted signals of the signal indicated by the reference numeral. However, in the specification below, inverted signals appear in parentheses, such as ( . . . ). In other words, d0, d1, . . . , dJ-3, dJ-2, dJ-1 and (d0), (d1), . . . , (dJ-3), (dJ-2), (dJ-1) indicate, respectively, signals in which the data latch output of the higher-order J bits has been shifted in level, and the inverted signals thereof.

In the diagram, d0 corresponds to the highest-order bit and dJ−1 corresponds to the lowest-order bit. The reference numerals V0 to v8M are higher-order gradation voltages. Reference numeral 51 is a p-channel MOSFET selection switch, and 52 is an n-channel MOSFET selection switch. Also, the number 8M of high-voltage higher-order gradation voltages v0 to v8M/2 is selected by the p-channel MOSFET 51, and the number 8M of the low-voltage higher-order gradation voltages v8M/2 to v8M is selected by the n-channel MOSFET 52. The level-shifted signals or the inverted signals thereof are inputted to the gates of the MOSFETS, and two adjacent voltages vl and vl+1 are selected from among the higher-order gradation voltages v0 to v8M.

The circuit diagram of the lower-order decoder unit 44 in FIG. 15 is the same as that shown in FIG. 6. In the diagram, dJ, dJ+1, . . . , dJ+K−3, dJ+K−2, dJ+K−1, and (dJ), (dJ+1), (dJ+K−3), (dJ+K−2), (dJ+K−1) indicate, respectively, signals in which the data latch output of the lower-order K bits has been shifted in level, and the inverted signals thereof. The signal dJ corresponds to the highest-order bit, and dJ+K−1 corresponds to the lowest-order bit. The reference numeral 61 is a complimentary MOSFET selection switch in which a p-channel MOSFET and an n-channel MOSFET are connected in parallel. The level-shifted signals or the inverted signals thereof are inputted to the gates of the MOSFETS, and output voltages are selected from among the generated gradation voltages vl0 to vln−1 obtained by equally dividing the voltage between the two adjacent higher-order gradation voltages vl and vl+1 selected by the higher-order decoder unit.

In the present embodiment, a buffer amplifier is provided between the output of the higher-order decoder unit and the input of the lower-order dividing resistor, the two adjacent higher-order gradation voltages selected by the higher-order decoder unit from the voltages generated by the higher-order dividing resistor are applied to the two ends of the lower-order dividing resistor via the buffer amplifier, and gradation voltages are generated and selected by the lower-order decoder unit. As a result, the two adjacent higher-order gradation voltages selected by the higher-order decoder unit are applied to the two ends of the lower-order dividing resistor via a high-impedance buffer amplifier. Therefore, the lower-order dividing resistor is connected in parallel between the two adjacent higher-order gradations, and the higher-order gradation voltages do not vary.

The higher-order decoder unit is composed of a p-channel MOSFET for selecting a high-voltage higher-order gradation voltage and an n-channel MOSFET for selecting a low-voltage higher-order gradation voltage. The lower-order decoder unit is composed entirely of complimentary MOSFETS in which a p-channel MOSFET and an n-channel MOSFET are connected in parallel. In accordance with this structure, the configuration of the MOSFETs of the higher-order decoder unit fixed to an inputted voltage can be simplified, and an increase in the on-resistance during selection can be prevented even if the higher-order gradation voltage inputted to the lower-order decoder unit varies.

### EXAMPLE 6

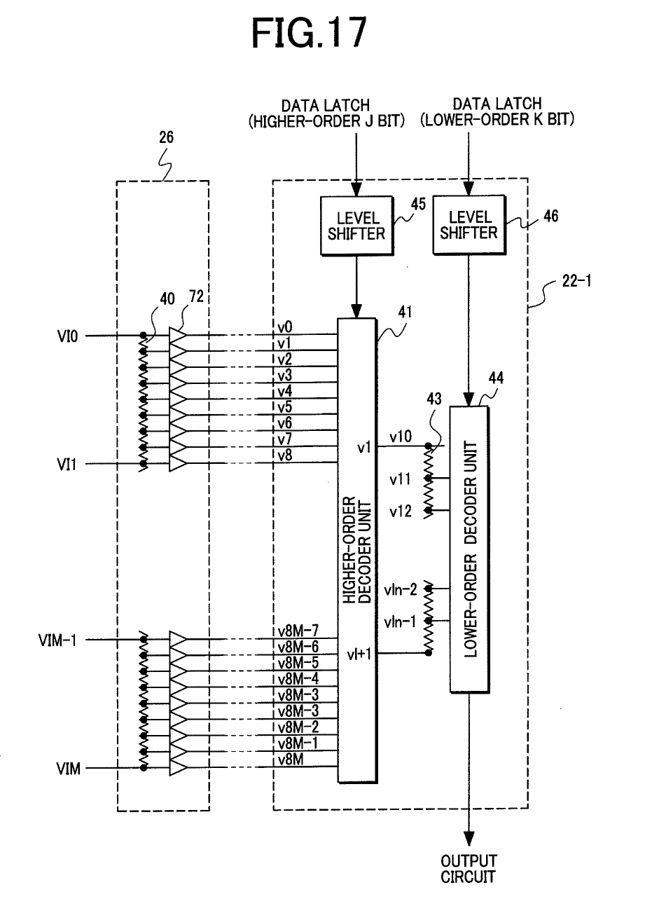

Example 6 has a buffer amplifier provided to the higher-order gradation voltage generator. FIG. 17 is a block diagram that describes the details of the unit 22-1 of each column of a decoder 22 and a higher-order gradation voltage generator 26 of example 6 of the image display device according to the present invention. In FIG. 17, VI0 to VIM, v0 to V8M, vl0 to vln−1, 40, 41, 43 to 46 are the same as in FIG. 15. Also, 72 is a buffer amplifier provided to each of the higher-order gradation voltages outputted from the higher-order dividing resistor 40.

The voltage is equally divided between the modulation circuit reference voltages VI0 to VIM by the higher-order dividing resistor 40 and higher-order gradation voltages v0 to v8M are generated. The higher-order gradation voltages thus generated are inputted to the unit 22-1 of each column of the decoder provided to each of the columns via the buffer amplifier 72, and the two adjacent higher-order gradation voltages vl and vl+1 are selected by the higher-order decoder unit 41 in accordance with the higher-order J bit data held in the data latch. The voltage is equally divided between the two selected higher-order gradation voltages by the lower-order dividing resistor 43, and a gradation voltage is generated. The output voltage is selectively outputted by the lower-order decoder unit in accordance with the data of the lower-order K bit from the gradation voltage.

In the present embodiment, the higher-order gradation voltages divided and generated by the higher-order dividing resistor are inputted to the unit of each column of the decoder via the buffer amplifier, the two adjacent higher-order gradation voltages selected by the higher-order decoder unit are applied to the two ends of the lower-order dividing resistor, and a gradation voltage is generated and selected by the lower-order decoder unit. The higher-order dividing resistor output is applied to the two ends of the lower-order dividing resistor via a high-impedance buffer amplifier. Therefore, the lower-order dividing resistor is connected in parallel between the two adjacent higher-order gradations selected by the higher-order decoder unit in the same manner as in example 5, and the higher-order gradation voltages do not vary.

### EXAMPLE 7

In example 5 described in FIG. 15, of the two higher-order gradation voltage vl and vl+1 selected by the higher-order decoder unit, the high-voltage higher-order gradation voltage vl is inputted to the two ends of the lower-order dividing resistor 43 via the buffer amplifier 42-1, and the low-voltage higher-order gradation voltage vl+1 is inputted to the two ends of the lower-order dividing resistor 43 via the buffer amplifier 42-2. As a result, the higher-order gradation voltages are inputted to the lower-order dividing resistor 43 via different buffer amplifiers in cases in which the higher-order gradation voltages are inputted to the high-voltage terminal of the lower-order dividing resistor 43 and in cases in which the input is made to the low-voltage terminal of the lower-order dividing resistor.

For this reason, the output voltage deviation of the different buffer amplifiers 42-1, 42-2 affects the maximum voltage vl0 outputted by the lower-order decoder unit when vl has been selected as the high-voltage higher-order gradation voltage, and affects the lowest voltage vl−1n−1 outputted by the lower-order decoder unit when vl−1 is selected as the high-voltage higher-order gradation voltage one gradation prior thereto. The voltage variation between the other gradations increases and image quality may degrade. The higher-order gradation voltages are configured in the present embodiment to be constantly applied to the two ends of the lower-order dividing resistor 43 via the same buffer amplifier in order to prevent such degradation in the image quality.

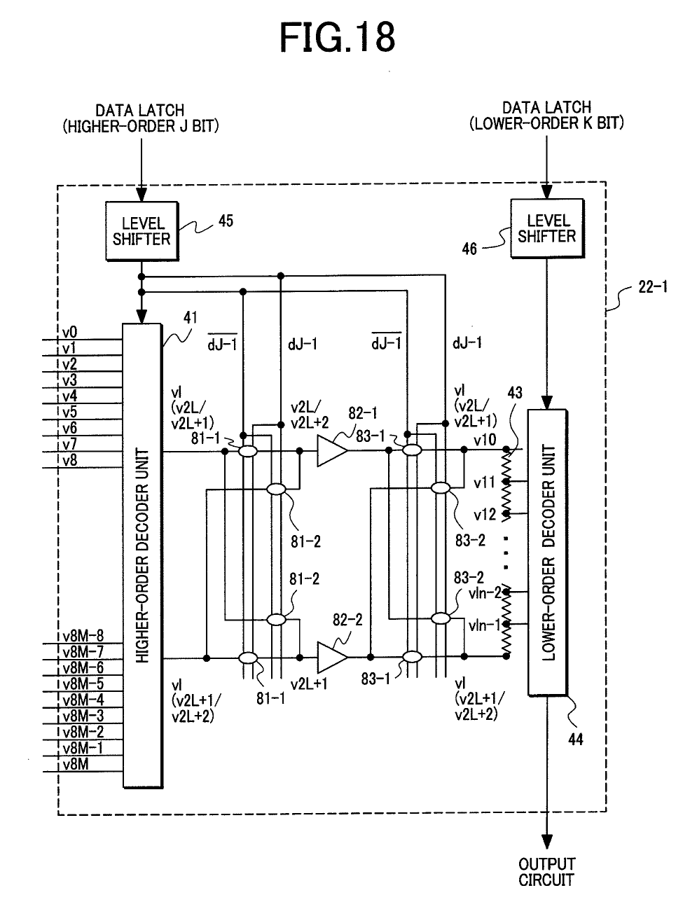

FIG. 18 is a block diagram showing the details of the unit 22-1 of each column of the decoder 22 shown in FIG. 15 of example 7 of the image display device according to the present invention. In the diagram, v0 to V8M, vl0 to vln−1, 41, 43 to 46 are the same as in FIG. 15. Also, 82-1, 82-2 are buffer amplifiers composed of voltage followers, and 81-1, 81-2, 83-1, 83-2 are complimentary MOSFET selection switches that are opened and closed by the lowest-order bit data inputted to the higher-order decoder unit provided to the I/O of the buffer amplifier.

The two adjacent higher-order gradation voltages vl and vl+1 are selected by the higher-order decoder unit 41 in the same manner as in example 5. When the lowest-order bit is 0 (1 is an even number 2L), the level-shifted inverted signal dJ−1 is brought to a high level, the selection switches 81-1 and 83-1 are switched on, the high-voltage higher-order gradation voltage v2L is inputted to the terminal on the high-voltage side of the lower-order dividing resistor 43 via the buffer amplifier 82-1, and the low-voltage higher-order gradation voltage v2L+1 is inputted to the terminal on the low-voltage side of the lower-order dividing resistor 43 via the buffer amplifier 82-2. On the other hand, when the lowest-order bit is 1 (1 is an odd number 2L+1), the signal dJ−1 is brought to a high level, the selection switches 81-2 and 83-2 are switched on, the high-voltage higher-order gradation voltage v2L+L is inputted to the terminal on the high-voltage side of the lower-order dividing resistor 43 via the buffer amplifier 82-2, and the low-voltage higher-order gradation voltage v2L+2 is inputted to the terminal on the low-voltage side of the lower-order dividing resistor 43 via the buffer amplifier 82-1.

As a result of the above, the even-numbered higher-order gradation voltages are inputted to the lower-order dividing resistor 43 via the buffer amplifier 82-1 and the odd-numbered higher-order gradation voltages, are inputted to the lower-order dividing resistor via the buffer amplifier 82-2 when input is made to the high-voltage terminal or to the low-voltage terminal of the lower-order dividing resistor 43.

In the present embodiment, two adjacent higher-order gradation voltages selected by the higher-order decoder unit are applied to the two ends of the lower-order dividing resistor via the buffer amplifier, and gradation voltages are generated. In this case, selection switches that are opened and closed in accordance with the lowest-order bit data inputted to the higher-order decoder unit are provided to the I/O of the buffer amplifier. The signal pathway is switched so that the same buffer amplifier is used for input in cases in which the higher-order gradation voltages are inputted to the high-voltage terminal of the lower-order dividing resistor 43 and in cases in which the input is made to the low-voltage terminal.

As a result of the above, the output voltage deviation of the same buffer amplifier 42-1 or 42-2 affects the maximum voltage vl0 outputted by the lower-order decoder unit when a particular higher-order gradation voltage has been selected as the high-voltage higher-order gradation voltage, and affects the minimum voltage vl−1n−1 outputted by the lower-order decoder unit when a particular gradation voltage of one gradation prior thereto has been selected as the low-voltage higher-order gradation voltage. The voltage variation between the two voltages is greater than that between other gradations, and image quality does not degrade even if the voltage deviation of the buffer amplifier outputs is considerable.

### EXAMPLE 8

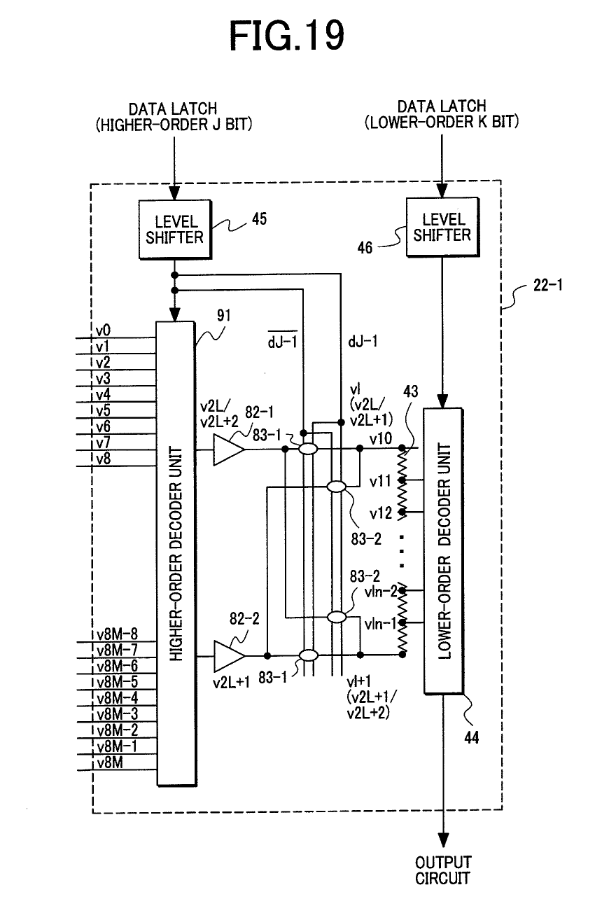

In example 8, a switching function for the selection switch on the input side of the buffer amplifier in example 7 of the present invention is provided to the higher-order decoder unit with the aim of simplifying the device. FIG. 19 is a block diagram showing the details of the unit 22-1 of each column of the decoder 22 shown in FIG. 15 according to example 8 of the present invention. In the diagram, v0 to V8M, vl0 to vln−1, and reference numerals 43 to 46 are the same as in FIG. 15. Reference numerals 82-1, 82-2, 81-1, 81-2, 83-1, 83-2 are the same as in FIG. 18. Reference numeral 91 is a higher-order decoder unit having a switching function for the selection switch.

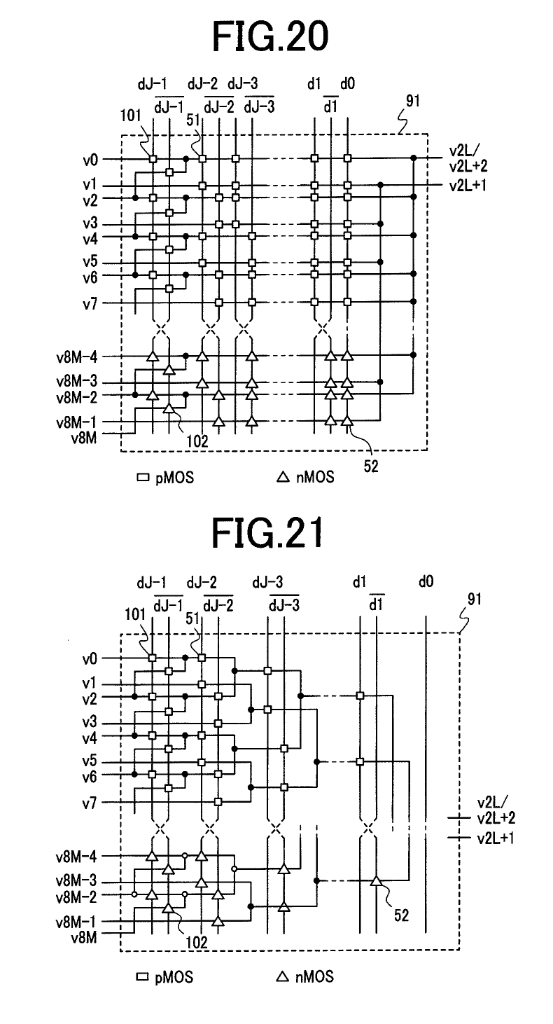

FIG. 20 is circuit diagram showing the details of the higher-order decoder unit 91 in FIG. 19. In the diagram, d0, d1, . . . , dJ-3, dJ-2, dJ-1 and (d0), (d1), . . . , (dJ-3), (dJ-2), (dJ-1), and the reference numerals 51 and 52 are the same as those of FIG. 16. Reference numerals 101 and 102 are a p-channel MOSFET and an n-channel MOSFET selection switches for selecting an adjacent even-numbered higher-order gradation voltage that is higher or lower than an odd-numbered higher-order gradation voltage in accordance with the lowest-order bit data input to the higher-order decoder unit.

In this case, the number 8M/2 of the high-voltage higher-order gradation voltages v0 to v8M/2−1 is selected by the p-channel MOSFETs 51 and 101, and the number 8M/2 +1 of the low-voltage higher-order gradation voltages v8M/2 to v8M is selected by the n-channel MOSFETs 52 and 102.

The two adjacent higher-order gradation voltages vl and vl+1 are selected from the higher-order gradation voltages v0 to v8M by the higher-order decoder unit 91 in accordance with the higher-order J bit data held in the data latch. When the lowest-order bit is 0 (1 is an even number 2L), the level-shifted signal dJ−1 is brought to a low level, and the high-voltage higher-order gradation voltage v2L is inputted to the buffer amplifier 82-1 and is applied to the high-voltage side of the lower-order dividing resistor 43 via the selection switch 83-1. The low-voltage higher-order gradation voltage v2L+1 is inputted to the buffer amplifier 82-2 and is applied to the low-voltage side of the lower-order dividing resistor 43 via the selection switch 83-1.

On the other hand, when the lowest-order bit is 1 (1 is an odd number 2L+1), the inverted signal dJ−1 is brought to a low level, and the high-voltage higher-order gradation voltage v2L+1 is inputted to the buffer amplifier 82-2 and is applied to the high-voltage input terminal of the lower-order dividing resistor 43 via the selection switch 83-2. The low-voltage higher-order gradation voltage v2L+2 is inputted to the buffer amplifier 82-1 and is applied to the lower-voltage input terminal of the lower-order dividing resistor 43 via the selection switch 83-1. As a result of the above, the even-numbered higher-order gradation voltages are inputted to the lower-order dividing resistor 43 via the buffer amplifier 82-1, and the odd-numbered higher-order gradation voltages are inputted to the lower-order dividing resistor 43 via the buffer amplifier 82-2 when input is made to the high-voltage terminal or to the low-voltage terminal of the lower-order dividing resistor 43.

In the present embodiment, signal pathway switching means for inputting the higher-order gradation voltages via the same buffer amplifier during input to the high-voltage terminal or the low-voltage terminal of the lower-order dividing resistor 43 is composed of switches provided to the higher-order decoder unit and used for selecting an adjacent even-numbered higher-order gradation voltage that is higher or lower than an odd-numbered higher-order gradation voltage of the higher-order decoder unit, and is further composed of selection switches provided to the buffer amplifier output. Switching is carried out in accordance with the lowest bit data inputted to the higher-order decoder unit.

As a result, the selection switches in the higher-order decoder unit can be configured as a single set, the number of switches constituting the decoder can be reduced by half, and the selection switch on the input side of the buffer amplifier can be dispensed with. In contrast, two sets of such switches are required in conventional practice. As a result, the chip size of the data driver can be reduced.

### EXAMPLE 9

The present invention can be implemented without the use of a higher-order decoder unit. The present embodiment is another configuration of the higher-order decoder unit in example 8. FIG. 21 is circuit diagram showing the details of the higher-order decoder unit 91 of example 9 of the image display device according to the present invention. In the diagram, d0, d1, . . . , dJ-3, dJ-2, dJ-1 and (d0), (d1), . . . , (dJ-3), (dJ-2), (dJ-1), v0 to v8M, and the reference numerals 51, 52 indicate the same functional parts as those in FIG. 16. Reference numerals 101, 102 indicate the same functional parts as those in FIG. 20.

In the present embodiment as well, the number of switches constituting the decoder can be reduced by half, and the selection switch on the input side of the buffer amplifier can be dispensed with in the same manner as in example 8. As a result, the chip size of the data driver can be reduced.

### EXAMPLE 10

The present invention may be implemented using any type of display panel as long as the panel is driven by amplitude modulation. Example 10 is one in which the present invention has been applied to a TFT liquid crystal display device driven by dot inversion. Driving by dot inversion is a type of common fixed driving in which the polarity of a voltage applied to the pixel electrodes is inverted for each column and each row.

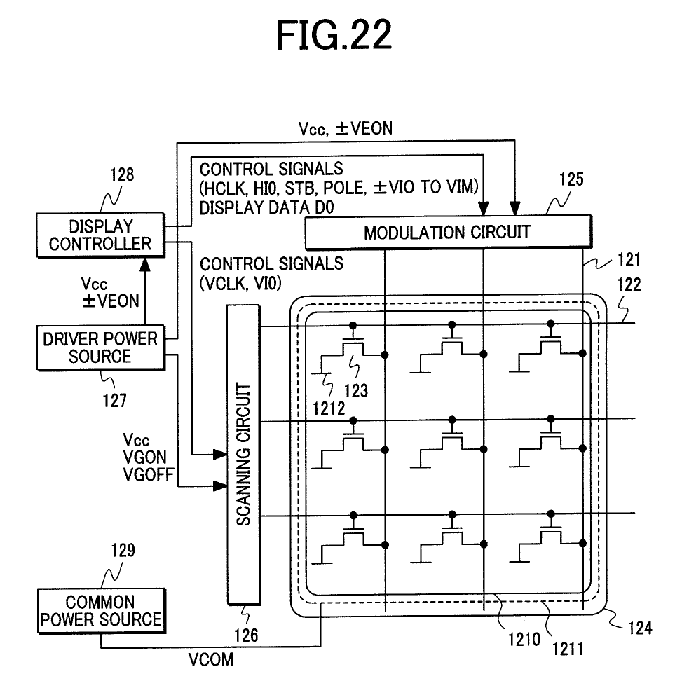

FIG. 22 is a block diagram showing the overall circuit configuration of example 10 of the image display device according to the present invention. A display panel 124 is composed of a back surface plate that is provided with TFTs 123, column lines 121 connected to the TFTs 123, row lines 122 connected to the gate electrodes of the TFTs 123, and pixel electrodes 1212 to which a modulation voltage applied to the column line 122 is applied; a front surface plate provided with a common electrode 1211 on the surface facing the back surface plate; and a liquid crystal 1210 which is sealed between the front and back surface plates and in which light transmittance is varied using the modulation voltage held in the pixel electrodes.

Reference numeral 125 is a modulation circuit for outputting an amplitude modulation voltage to the column lines 122, and reference numeral 126 is a scanning circuit for selecting rows. A driver power source 127 supplies a selection voltage VGON, a non-selection voltage VGOFF, and a logic circuit voltage Vcc to the scanning circuit 126, and supplies a positive or negative emission voltage ±VEON and a logic circuit voltage Vcc to the modulation circuit 125 and a display controller 128. The display controller 128 applies a vertical clock VCLK and a start pulse VIO to the scanning circuit 126, and presents the modulation circuit 125 with a horizontal clock HCLK, a start pulse HIO, an output switching signal STB, an output positive/negative switching signal POLE, a positive/negative modulation circuit reference voltage ±VI0 to VIM, and display data D0. Among these control signals and data, all the signals other than the modulation circuit reference voltages ±VI0 to VIM, have the amplitude of the logic circuit voltage Vcc. A common power source 129 presents the common electrode 1211 with a common voltage VCOM, which is the reference of the voltage applied to the liquid crystal 1210.

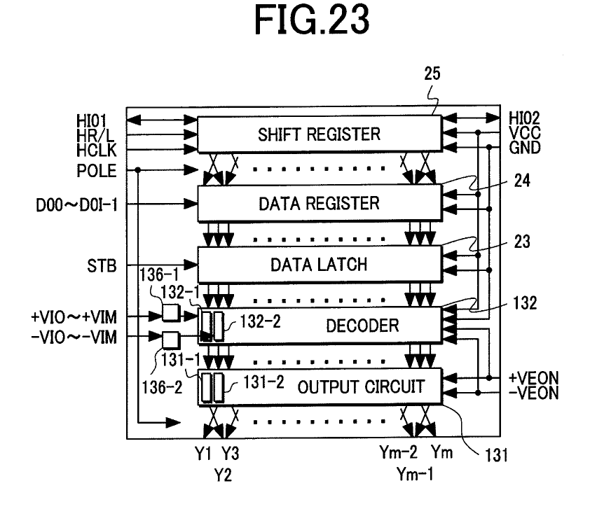

FIG. 23 is a block diagram of the data driver constituting the modulation circuit in FIG. 22. In the data driver, reference numerals 25, 24, and 23 are the same functional parts as those in FIG. 2. In the diagram, +VI0 to (VIM((VI0((VI1, (((VIM(1((VIM) are positive modulation circuit reference voltages in which a prescribed range, i.e., from the positive maximum emission voltage VEON to the common voltage, is divided. Reference numerals (VI0 to (VIM((VI0<(VI1, (<(VIM(1<(VIM) are negative modulation circuit reference voltages in which a prescribed range, i.e., from the negative maximum emission voltage (VEON to the common voltage, is divided. Reference numerals 136-1 and 136-2 are positive-pole or negative-pole higher-order gradation voltage generators in which resistance division is used to generate the number 2^{J}+1 of positive or negative higher-order gradation voltages from the positive modulation circuit reference voltages +VI0 to VIM or the negative modulation circuit reference voltages −VI0 to VIM, respectively.

Reference numerals 132-1 and 132-2 are positive-pole or negative-pole decoders for generating and outputting 2^{I} (I>J) voltages using the number 2^{J}+1 of positive or negative higher-order gradation voltages in accordance with I bits of display data outputted by the data latch. Reference numerals 131-1 and 131-2 are positive-pole or negative-pole output circuits composed of voltage followers for outputting the decoder output voltages as the output voltages Y1 to Ym to the column lines 121 of the display panel 124. The positive-pole decoder and output circuit, as well as the negative-pole decoder and output circuit, are alternately disposed for each column. HR/L is a signal for determining the shift direction of the shift register and is fixed to the logic circuit voltage Vcc or the ground voltage GND.

When a single horizontal scanning interval is started, a start pulse HIO is inputted as an HIO1 (or HIO2) signal of a first data driver, and the registers in the shift register 25 perform a shift operation in synchronization with the horizontal clock HCLK. When a latch signal is outputted, the outputted I bits of display data are sequentially received by the data register 24. When the display data has been received by the data register 24 of the first data driver, the voltage of the HIO2 (or HIO1) assumes the value of the logic circuit voltage Vcc and is inputted to HIO1 (or HIO2) terminal of the second data driver, and the receipt of the display data into the second data driver is started.

When the receipt of all display data into the data register 24 is completed in this manner, all the display data is received from the data register 24 into the data latch 23 in synchronization with the rise of the output switching signal STB immediately prior to the single horizontal scanning interval. The display data thus received in the data latch 23 is converted to gradation voltage by the positive-pole decoder unit 132-1 or the negative-pole decoder unit 132-2, and the gradation voltages thus converted are outputted to the column lines via the positive-pole output circuit 131-1 or the negative-pole output circuit 131-2. As a result of the above, a voltage that is positive or negative in relation to the common voltage VCOM is outputted in alternating fashion to the column lines.

The output positive/negative switching signal POLE assumes the value 0 and 1 in alternating fashion for each horizontal scanning interval, and the voltage output to the column lines is made positive or negative for each horizontal scan line. When the output positive/negative switching signal POLE is 0, the display data corresponding to the output to the odd-numbered column lines is received by the odd-numbered addresses of the data register 24 and is outputted to the odd-numbered column lines Y1, Y3, . . . as positive voltage by the positive-pole decoder unit 132-1 and the positive-pole output circuit 131-1. The display data corresponding to the output to the even-numbered column lines is received by the even-numbered addresses of the data register 24, is converted to negative voltage by the negative-pole decoder unit 132-2 and the negative-pole output circuit 131-2, and is outputted to the even-numbered column lines Y2, . . . as negative voltage. On the other hand, when the output positive/negative switching signal POLE is 1, the display data corresponding to the output to the odd-numbered column lines is received by the even-numbered addresses of the data register 24, and is outputted to the odd-numbered column lines Y1, Y3, . . . as negative voltage by the negative-pole decoder unit 132-2 and the negative-pole output circuit 131-2.

The display data corresponding to the output to the even-numbered column lines is received by the odd-numbered addresses of the data register 24, is converted to negative voltage by the positive-pole decoder unit 132-1 and the positive-pole output circuit 131-2, and is outputted to the even-numbered column lines Y2, . . . as negative voltage. As a result of the above, the output positive/negative switching signal POLE is switched, whereby the voltage output to the column lines assumes the value of a positive or negative voltage for each of the horizontal scanning lines.

The positive-pole or the negative-pole higher-order gradation voltage generators 136-1 and 136-2 in the data driver shown in FIG. 23 are the same as those denoted by reference numeral 26 of FIG. 15, and the configuration of the units of each column of the positive-pole or the negative-pole decoders 132-1 and 132-2 is the same as that of 22-1 in FIG. 19. In the positive-pole decoder unit 132-1, the selection switches 81-1, 81-2, 83-1, 83-2 are composed of p-channel MOSFETS.

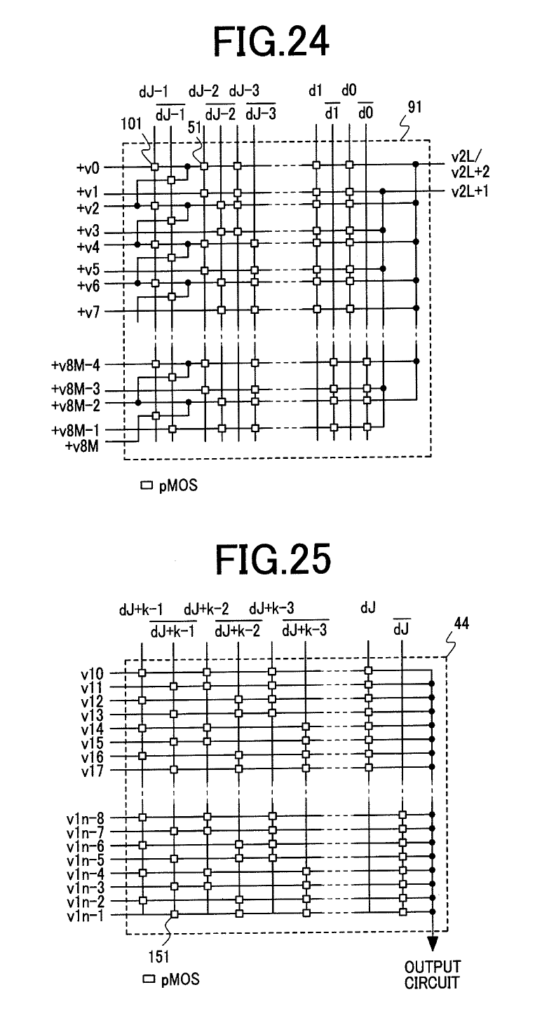

FIG. 24 is a circuit diagram showing the configuration of the positive-pole higher-order decoder unit in example 10 of the present invention. In the higher-order decoder unit 91, d0, d1, . . . , dJ-3, dJ-2, dJ-1 and (d0), (d1), . . . , (dJ-3), (dJ-2), (dJ-1) indicate, respectively, signals in which the data latch output of the higher-order J bits has been converted from the level of the logic circuit voltage Vcc-GND to a positive maximum emission voltage +VEON and a negative maximum emission voltage −VEON, and the inverted signals thereof. In the diagram, d0 corresponds to the highest-order bit and dJ−1 corresponds to the lowest-order bit.

Also, +v0 to +v8M are positive higher-order gradation voltages. Reference numeral 51 is a p-channel MOSFET selection switch in the same manner as in FIG. 16, and reference numeral 101 is a p-channel MOSFET in the same manner as in FIG. 20. The level-shifted signals or the inverted signals thereof are inputted to the gates of the p-channel MOSFETs, respectively, and two adjacent voltages v2L+1 and v2L or v2L+2 are selected from among the higher-order gradation voltages +v0 to +v8M in the same manner as FIG. 20.

FIG. 25 is a circuit diagram showing the details of the lower-order decoder unit 44 shown in FIG. 19 of the positive-pole decoder in example 10 of the present invention. In the diagram, dJ, dJ+1, . . . , dJ+K−3, dJ+K−2, dJ+K−1, and (dJ), (dJ+1), . . . , (dJ+K−3), (dJ+K−2), (dJ+K−1) indicate, respectively, signals in which the data latch output of the lower-order K bits has been shifted in level, and the inverted signals thereof. The signal dJ corresponds to the highest-order bit, and dJ+K−1 corresponds to the lowest-order bit. The reference numeral 151 is a p-channel MOSFET selection switch. The level-shifted signals or the inverted signals thereof are inputted to the gates of the MOSFETS, and output voltages are selectively outputted from among the gradation voltages vl0 to vln−1 that are generated by equally dividing the voltage between the two adjacent higher-order gradation voltages vl and vl+1.

On the other hand, in the negative-pole decoder, the selection switches 81-1, 81-2, 83-1, 83-2 of FIG. 19, the selection switches 51, 101 of the higher-order decoder unit shown in FIG. 24, and the selection switch 151 of the lower-order decoder unit shown in FIG. 25 are all composed of an n-channel MOSFET. A level shift signal obtained by converting the data latch output, as well as a polarity-inverted signal, which is an inverted signal of the level shift signal, are inputted to the higher-order decoder unit and the lower-order decoder unit.

In example 10, the higher-order decoder unit and the lower-order decoder unit of the positive-pole decoder are composed of p-channel MOSFETs, and the higher-order decoder unit and the lower-order decoder unit of the negative-pole decoder are composed of n-channel MOSFETs, whereby the configuration of the decoder can be simplified and the chip size of the data driver can be reduced.

In examples 5 to 9, modulation circuit reference voltages VI0 to VIM are voltages in which a prescribed range, i.e., from the non-emission voltage VEOFF to the maximum emission voltage VEON, is equally divided into M parts, but an unequal division may also be used in accordance with the required display quality and the relationship between the voltage of the electron emission element and the emission current characteristics toward the front surface plate. The parts of the modulation circuit reference voltages VI0 to VIM are equally divided by the higher-order dividing resistor 40 to generate higher-order gradation voltages v0 to v8M. In a similar manner, an unequal division may also be used in accordance with the required display quality and the relationship between the voltage of the electron emission element and the emission current characteristics toward the front surface plate.

In example 10, a case was described in which a display controller 8 outputs display data DO for a monochrome display, but the present invention can also be implemented in the same manner in a case in which three outputs, i.e., display data D0, D1, D2, for a color display are outputted.

Also, in example 10, a common electrode 1211 is provided to the front surface plate, but the present invention can also be implemented in the same manner for a case in which a common electrode is located on the front surface plate in the same manner as in an in-plane switching liquid crystal display panel. In examples 8 to 10, a switch for selecting an adjacent even-numbered higher-order gradation voltage that is higher or lower than an odd-numbered higher-order gradation voltage of the higher-order decoder unit is provided as signal pathway switching means to the higher-order decoder unit, but it is apparent that a switch for selecting an adjacent odd-numbered higher-order gradation voltage that is higher or lower than an even-numbered higher-order gradation voltage of the higher-order decoder unit may be provided.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image display device comprising:
a display panel having a plurality of mutually parallel row lines, a plurality of column lines that intersect with the row lines, a back surface plate in which display elements are disposed in a vicinity of the intersections of the row lines and the column lines to form a display area, and a front surface plate superposed so as to cover at least the display area of the back surface plate, wherein
the back surface plate has a scanning circuit which is connected to the row lines and which performs row selection, and a modulation circuit which is connected to the column lines and which outputs amplitude modulation voltage,
the modulation circuit has a higher-order gradation voltage generator that has a higher-order dividing resistor for dividing an externally inputted modulation circuit reference voltage and generating higher-order gradation voltages, a data latch for holding display data, and a decoder comprising a higher-order decoder unit for selecting two adjacent voltages from the higher-order gradation voltages in accordance with the data of the higher-order bits held in the data latch, and a lower-order decoder unit for dividing the voltage between the two selected higher-order gradation voltages and generating a gradation voltage to selectively output an output voltage of voltage dividing means for outputting the gradation voltage generated in accordance with the data of the lower-order bits held in the data latch,
the higher-order decoder unit has a switch for selecting an adjacent even-numbered or adjacent odd-numbered higher-order gradation voltage that is higher or lower than an odd-numbered or even-numbered higher-order gradation voltage of the higher-order decoder unit, and
the decoder has a selection switch for selecting the output voltage of the voltage dividing means between the higher-order decoder unit and the voltage dividing means.

2. The image display device of claim 1, wherein
the higher-order decoder unit is comprising a p-channel MOSFET for selecting a high-voltage higher-order gradation voltage, and an n-channel MOSFET for selecting a low-voltage higher-order gradation voltage; and
the lower-order decoder unit is comprising a complimentary MOSFET in which a p-channel MOSFET and an n-channel MOSFET are connected in parallel.

3. The image display device of claim 1, wherein
the display elements of the back surface plate are thin film electron source connected to the column lines and is composed of a thin film electrode layered via an insulation film on the row lines, and
the front surface plate has opposing electrodes for applying voltage that accelerates electrons emitted from the thin film electron source.

4. The image display device of claim 3, wherein
the front surface plate has a phosphor for emitting light by being excited with electrons emitted from the thin film electron source.

5. The image display device of claim 4, wherein
the phosphor is formed by being partitioned for each of the thin film electron sources.

6. The image display device of claim 1, wherein
the display elements of the back surface plate have a liquid crystal sealed between the front surface plate and pixel electrodes selected by the column lines and driven by a thin film transistor to which display data is fed via the row lines, and are light shutter elements for controlling an orientation of the liquid crystal by using an electric field formed between the pixel electrodes and a common electrode.

7. The image display device of claim 6, wherein
the common electrode is formed adjacent to the pixel electrodes on the back surface plate.

8. The image display device of claim 6, wherein
the common electrode is formed on the front surface plate.

9. An image display device comprising:
a display panel having a plurality of mutually parallel row lines, a plurality of column lines that intersect with the row lines, a back surface plate in which display elements are disposed in a vicinity of the intersections of the row lines and the column lines to form a display area, and a front surface plate superposed so as to cover at least the display area of the back surface plate, wherein
the back surface plate has a scanning circuit which is connected to the row lines and which performs row selection, and a modulation circuit which is connected to the column lines and which outputs amplitude modulation voltage,
the modulation circuit has a higher-order gradation voltage generator that has a higher-order dividing resistor for dividing an externally inputted modulation circuit reference voltage and generating higher-order gradation voltages, a data latch for holding display data, and a decoder comprising a higher-order decoder unit for selecting two adjacent voltages from the higher-order gradation voltages in accordance with the data of the higher-order bits held in the data latch, and a lower-order decoder unit for dividing the voltage between the two selected higher-order gradation voltages and generating a gradation voltage to selectively output an output voltage of voltage dividing means for outputting the gradation voltage generated in accordance with the data of the lower-order bits held in the data latch, and
a buffer amplifier is provided between the higher-order dividing resistor and the lower-order dividing resistor.

10. The image display device of claim 9, wherein
the buffer amplifier is disposed between an output of the higher-order decoder unit and an input terminal of the lower-order dividing resistor.

11. The image display device of claim 10, wherein
the decoder has signal pathway switching means for providing input via the same buffer amplifier in both of a case in which the higher-order gradation voltages are inputted to a high-voltage terminal of the lower-order dividing resistor and a case in which the input is made to the low-voltage terminal.

12. The image display device of claim 9, wherein
the signal pathway switching means is comprising a switch which is provided to the higher-order decoder unit and which selects an adjacent even-numbered or odd-numbered higher-order gradation voltage that is higher or lower than an odd-numbered or even-numbered higher-order gradation voltage of the higher-order decoder unit, and a selection switch provided to the buffer amplifier output.

13. The image display device of claim 9, wherein
the higher-order decoder unit is comprising a p-channel MOSFET for selecting a high-voltage higher-order gradation voltage, and an n-channel MOSFET for selecting a low-voltage higher-order gradation voltage; and the lower-order decoder unit is comprising a complimentary MOSFET in which a p-channel MOSFET and an n-channel MOSFET are connected in parallel.

14. The image display device of claim 9, wherein
the display elements of the back surface plate are thin film electron sources connected to the column lines and are composed of thin film electrodes layered via an insulation film on the row lines, and
the front surface plate has opposing electrodes for applying voltage that accelerates electrons emitted from the thin film electron source.

15. The image display device of claim 14, wherein
the front surface plate has a phosphor for emitting light by being excited with electrons emitted from the thin film electron source.

16. The image display device of claim 15, wherein
the phosphor is formed by being partitioned for each of the thin film electron sources.

17. The image display device of claim 9, wherein
the display elements of the back surface plate have a liquid crystal sealed between the front surface plate and pixel electrodes selected by the column lines and driven by a thin film transistor to which display data is fed via the row lines, and are light shutter elements for controlling an orientation of the liquid crystal by using an electric field formed between the pixel electrodes and a common electrode.

18. The image display device of claim 17, wherein
the common electrode is formed adjacent to the pixel electrodes on the back surface plate.

19. The image display device of claim 17, wherein
the common electrode is formed on the front surface plate.
